(19) United States
(12) Patent Application Publication
(10) Pub. No.: US 2023/0126370 A1
(43) Pub. Date: Apr. 27, 2023

(54) TECHNIQUES FOR BANDWIDTH PART SWITCHING

(71) Applicant: QUALCOMM Incorporated, San Diego, CA (US)

(72) Inventors: Muhammad Nazmul Islam, Littleton, MA (US); Jing Lei, San Diego, CA (US); Carsten Aagaard Pedersen, Bolton, MA (US); Murali Menon, Acton, MA (US); Prashant Sharma, San Jose, CA (US); Changhwan Park, San Diego, CA (US); Peter Gaal, San Diego, CA (US); Peter Pui Lok Ang, San Diego, CA (US)

(21) Appl. No.: 17/944,074

(22) Filed: Sep. 13, 2022

Related U.S. Application Data
(60) Provisional application No. 63/270,541, filed on Oct. 21, 2021.

(51) Int. Cl. H04W 28/02

(52) U.S. Cl. CPC H04W 28/0257

(57) ABSTRACT

Methods, systems, and devices for wireless communication are described. A user equipment (UE), such as a UE with reduced capabilities, may switch from a first bandwidth part (BWP) to a second BWP to receive system information for a carrier that includes the first and second BWPs. The UE may switch to the second BWP to receive system information based on a trigger (e.g., control signaling or an expiration of a timer) and then switch back to the first BWP without additional signaling to continue operation. In some examples, the UE may receive additional signaling (e.g., data, control signaling, reference signals) in the second BWP. In some examples, a BWP switching duration may include additional time to process the system information received in the second BWP, for example if the system information includes instructions to switch to a third BWP (e.g., rather than returning to the first BWP).

### CROSS REFERENCE

The present application for patent claims the benefit of U.S. Provisional Patent Application No. 63/270,541 by ISLAM et al., entitled “TECHNIQUES FOR BANDWIDTH PART SWITCHING,” filed Oct. 21, 2021, assigned to the assignee hereof, and expressly incorporated by reference herein.

### FIELD OF TECHNOLOGY

The following relates to wireless communication, including techniques for bandwidth part (BWP) switching.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless communications system may include one or more network entities (e.g., base stations) or one or more network access nodes, each simultaneously supporting communication for multiple communication devices, which may be otherwise known as user equipment (UE). Some wireless communications systems may support communication between network entities and UEs with various capabilities. As demand for UE efficiency increases, some wireless communications systems may fail to efficiently manage network access for UEs with differing capabilities.

### SUMMARY

The described techniques relate to improved methods, systems, devices, and apparatuses that support techniques for BWP switching. Generally, the described techniques provide for enabling a UE, such as a UE with reduced capabilities, to switch from a first BWP to a second BWP to receive system information for a carrier that includes the first and second BWPs. The UE may switch to the second BWP to receive system information based on a trigger (e.g., control signaling or an expiration of a timer) and then switch back to the first BWP without additional signaling to continue operation. In some examples, the UE may receive additional signaling (e.g., data, control signaling, reference signals) in the second BWP. In some examples, a BWP switching duration may include additional time to process the system information received in the second BWP, for example if the system information includes instructions to switch to a third BWP (e.g., rather than returning to the first BWP).

A method for wireless communication at a UE is described. The method may include monitoring for a first signal in a first BWP of a carrier, and receiving a second signal in a second BWP of the carrier based on a trigger indicating that the UE is to receive the second signal in the second BWP, the second signal including system information for the carrier, a paging message, or both.

An apparatus for wireless communication at a UE is described. The apparatus may include a processor, memory coupled with the processor, and instructions stored in the memory. The instructions may be executable by the processor to cause the apparatus to monitor for a first signal in a first BWP of a carrier, and receive a second signal in a second BWP of the carrier based on a trigger indicating that the UE is to receive the second signal in the second BWP, the second signal including system information for the carrier, a paging message, or both.

Another apparatus for wireless communication at a UE is described. The apparatus may include means for monitoring for a first signal in a first BWP of a carrier, and means for receiving a second signal in a second BWP of the carrier based on a trigger indicating that the UE is to receive the second signal in the second BWP, the second signal including system information for the carrier, a paging message, or both.

A non-transitory computer-readable medium storing code for wireless communication at a UE is described. The code may include instructions executable by a processor to monitor for a first signal in a first BWP of a carrier, and receive a second signal in a second BWP of the carrier based on a trigger indicating that the UE is to receive the second signal in the second BWP, the second signal including system information for the carrier, a paging message, or both.

Some examples of the method, apparatuses, and non-transitory computer-readable medium described herein may further include operations, features, means, or instructions for monitoring for a third signal in a third BWP of the carrier based on a scheduling parameter associated with receiving the second signal.

Some examples of the method, apparatuses, and non-transitory computer-readable medium described herein may further include operations, features, means, or instructions for receiving a control signal, where the trigger indicating that the UE may receive the second signal in the second BWP includes the control signal.

In some examples of the method, apparatuses, and non-transitory computer-readable medium described herein, the control signal further includes an indication of a switch from the second BWP to a third BWP, the scheduling parameter associated with receiving the second signal, a downlink control information (DCI) message, a medium access control (MAC) control element (MAC-CE), a radio resource control (RRC) message, or any combination thereof.

In some examples of the method, apparatuses, and non-transitory computer-readable medium described herein, the trigger indicating that the UE may receive the second signal in the second BWP includes an expiration of a timer.

In some examples of the method, apparatuses, and non-transitory computer-readable medium described herein, each of a first switch duration corresponding to switching from the first BWP to the second BWP and a second switch duration corresponding to switching from the second BWP to a third BWP is based at least in part on a subcarrier spacing of the carrier, a frequency range of the carrier, a UE capability parameter, or any combination thereof.

In some examples of the method, apparatuses, and non-transitory computer-readable medium described herein, the UE capability parameter comprises a duplexing mode parameter, a quantity of phase locked loops associated with tracking signals at the UE, or both.

In some examples of the method, apparatuses, and non-transitory computer-readable medium described herein, a first switch duration corresponding to switching from the first BWP to the second BWP, a duration corresponding to receiving the second signal in the second BWP, a second switch duration corresponding to switching from the second BWP to a third BWP, or any combination thereof, correspond to a scheduled measurement gap.

In some examples of the method, apparatuses, and non-transitory computer-readable medium described herein, a first switch duration corresponding to switching from the first BWP to the second BWP is based at least in part on one or more reference signals associated with receiving signaling in the second BWP, and the second signal has a quasi-co-location (QCL) relationship with the one or more reference signals.

In some examples of the method, apparatuses, and non-transitory computer-readable medium described herein, a second switch duration corresponding to switching from the second BWP to a third BWP is based at least in part on one or more reference signals associated with receiving signaling in the third BWP, and a third signal has a QCL relationship with the one or more reference signals.

In some examples of the method, apparatuses, and non-transitory computer-readable medium described herein, the second switch duration is further based at least in part on a first processing duration associated with processing the one or more reference signals, a second processing duration associated with processing the second signal, or both. In some examples of the method, apparatuses, and non-transitory computer-readable medium described herein, a first switch duration corresponding to switching from the first BWP to the second BWP is different than a second switch duration corresponding to switching from the second BWP to a third BWP.

In some examples of the method, apparatuses, and non-transitory computer-readable medium described herein, the system information for the carrier comprises one or more system information blocks (SIBs), and a SIB of the one or more SIBs comprises a position reference signal. In some examples of the method, apparatuses, and non-transitory computer-readable medium described herein, the first BWP and a third BWP are a same BWP.

Some examples of the method, apparatuses, and non-transitory computer-readable medium described herein may further include operations, features, means, or instructions for receiving, in the first signal, a message indicating that the UE is to receive updated system information, wherein the trigger indicating that the UE is to receive the second signal in the second BWP comprises the message in the first signal. In some examples of the method, apparatuses, and non-transitory computer-readable medium described herein, the message in the first signal comprises a paging DCI message.

In some examples of the method, apparatuses, and non-transitory computer-readable medium described herein, the message in the first signal indicates one or more SIBs that may be updated for a system information modification period, the one or more SIBs including a master information block (MIB), a first SIB (SIB1), other system information (OSI), or any combination thereof and receiving the second signal in the second BWP may be further based on the message in the first signal indicating the one or more SIBs that may be updated for the system information modification period.

In some examples of the method, apparatuses, and non-transitory computer-readable medium described herein, the message in the first signal further indicates a UE type associated with the updated system information.

In some examples of the method, apparatuses, and non-transitory computer-readable medium described herein, the system information in the second signal may be first system information and the method, apparatuses, and non-transitory computer-readable medium may include further operations, features, means, or instructions for receiving, after monitoring for a third signal in a third BWP of the carrier, a fourth signal in the second BWP of the carrier based at least in part on receiving the message in the first signal and on the scheduling parameter, the fourth signal comprising second system information for the carrier.

In some examples of the method, apparatuses, and non-transitory computer-readable medium described herein, the fourth signal is received based at least in part on a quantity of slots between a first search space comprising the first system information and a second search space comprising the second system information, a first scheduling offset associated with the first system information, a second scheduling offset associated with the second system information, a UE capability parameter, or any combination thereof.

Some examples of the method, apparatuses, and non-transitory computer-readable medium described herein may further include operations, features, means, or instructions for transmitting an uplink signal in response to receiving the system information in the second signal, and monitoring for a third signal in a third BWP of the carrier based at least in part on transmitting the uplink signal.

In some examples of the method, apparatuses, and non-transitory computer-readable medium described herein, the system information in the second signal may be first system information and the method, apparatuses, and non-transitory computer-readable medium may include further operations, features, means, or instructions for receiving, after monitoring for the third signal, a fourth signal in the second BWP of the carrier based at least in part on receiving the message in the first signal and on transmitting the uplink signal, the fourth signal comprising second system information for the carrier.

In some examples of the method, apparatuses, and non-transitory computer-readable medium described herein, the system information in the second signal may be first system information and the method, apparatuses, and non-transitory computer-readable medium may include further operations, features, means, or instructions for refraining from monitoring for a fourth signal in the second BWP of the carrier based at least in part on receiving the message in the first signal and on transmitting the uplink signal, the fourth signal comprising second system information for the carrier.

Some examples of the method, apparatuses, and non-transitory computer-readable medium described herein may further include operations, features, means, or instructions for monitoring for the third signal in the third BWP is based at least in part on transmitting the uplink signal.

Some examples of the method, apparatuses, and non-transitory computer-readable medium described herein may further include operations, features, means, or instructions for transmitting a fourth signal indicating a beam failure recovery procedure based at least in part on a beam quality in the first BWP failing to satisfy a threshold.

Some examples of the method, apparatuses, and non-transitory computer-readable medium described herein may further include operations, features, means, or instructions for receiving, in a third signal, a message indicating that the UE is to receive updated system information, and refraining from receiving the updated system information based at least in part on transmitting the fourth signal indicating the beam failure recovery procedure.

A method for wireless communication is described. The method may include transmitting, to a UE, a first signal in a first BWP of a carrier, and transmitting a second signal in a second BWP of the carrier based on a trigger indicating that the UE is to receive the second signal in the second BWP, the second signal including system information for the carrier, a paging message, or both.

An apparatus for wireless communication is described. The apparatus may include a processor, memory coupled with the processor, and instructions stored in the memory. The instructions may be executable by the processor to cause the apparatus to transmit, to a UE, a first signal in a first BWP of a carrier, and transmit a second signal in a second BWP of the carrier based on a trigger indicating that the UE is to receive the second signal in the second BWP, the second signal including system information for the carrier, a paging message, or both.

Another apparatus for wireless communication is described. The apparatus may include means for transmitting, to a UE, a first signal in a first BWP of a carrier, and means for transmitting a second signal in a second BWP of the carrier based on a trigger indicating that the UE is to receive the second signal in the second BWP, the second signal including system information for the carrier, a paging message, or both.

A non-transitory computer-readable medium storing code for wireless communication is described. The code may include instructions executable by a processor to transmit, to a UE, a first signal in a first BWP of a carrier, and transmit a second signal in a second BWP of the carrier based on a trigger indicating that the UE is to receive the second signal in the second BWP, the second signal including system information for the carrier, a paging message, or both.

### BRIEF DESCRIPTION OF THE DRAWINGS

FIGS. 1 and 2 illustrate examples of wireless communications systems that support techniques for BWP switching in accordance with aspects of the present disclosure.

FIGS. 3 and 4 illustrate examples of transmission schemes that support techniques for BWP switching in accordance with aspects of the present disclosure.

FIG. 5 illustrates an example of a process flow that supports techniques for BWP switching in accordance with aspects of the present disclosure.

FIGS. 6 and 7 show block diagrams of devices that support techniques for BWP switching in accordance with aspects of the present disclosure.

FIG. 8 shows a block diagram of a communications manager that supports techniques for BWP switching in accordance with aspects of the present disclosure.

FIG. 9 shows a diagram of a system including a device that supports techniques for BWP switching in accordance with aspects of the present disclosure.

FIGS. 10 and 11 show block diagrams of devices that support techniques for BWP switching in accordance with aspects of the present disclosure.

FIG. 12 shows a block diagram of a communications manager that supports techniques for BWP switching in accordance with aspects of the present disclosure.

FIG. 13 shows a diagram of a system including a device that supports techniques for BWP switching in accordance with aspects of the present disclosure.

FIGS. 14 through 17 show flowcharts illustrating methods that support techniques for BWP switching in accordance with aspects of the present disclosure.

### DETAILED DESCRIPTION

Some wireless communication systems may include UE and one or more network entities, for example, base stations such as next-generation NodeBs or giga-NodeBs (either of which may be referred to as a gNB) that may support one or more multiple radio access technologies, including 4G systems such as LTE systems, 5G systems which may be referred to as NR systems, and Wi-Fi systems (e.g., wireless local area network (WLAN) systems). UEs in a wireless communications system may be specialized for particular uses, such as wearable devices, vehicles, industrial sensors, cameras, video monitoring equipment, Internet of Things (IoT) devices, etc. Such specialized devices may have reduced capabilities (e.g., bandwidth capabilities, beamforming capabilities, among other examples) compared with other UEs in the wireless communications system, to improve efficiency and provide other benefits.

UEs with reduced capability may be enabled to communicate with a network entity in a BWP of a carrier, where the BWP may be smaller than a BWP other UEs in the wireless communications system may use (e.g., due to a reduced bandwidth capability). As such, the BWP of a UE with reduced capability may not include the portion of the BWP of the carrier that includes system information for the carrier (e.g., in a control resource set (CORESET) or a synchronization signal block (SSB)). It may be beneficial to establish an efficient timeline for a UE with reduced capability to switch to a BWP to receive system information.

The techniques described herein may enable a UE to switch from a first BWP (which may be referred to as an active BWP) to a second BWP (which may be referred to as an initial BWP) to receive system information for a carrier that includes the first and second BWPs. A UE may switch to the second BWP to receive system information based on a trigger (e.g., control signaling or an expiration of a timer) and then switch back to the first BWP without additional signaling to continue operation. In some examples, the UE may receive additional signaling (e.g., data, control signaling, reference signals) in the second BWP. In some examples, a BWP switching duration may include additional time to process the system information received in the second BWP, for example if the system information includes instructions to switch to a third BWP (e.g., rather than returning to the first BWP).

Aspects of the disclosure are initially described in the context of wireless communications systems. Aspects of the disclosure are further illustrated by and described with reference to transmission schemes, a process flow, apparatus diagrams, system diagrams, and flowcharts that relate to techniques for BWP switching.

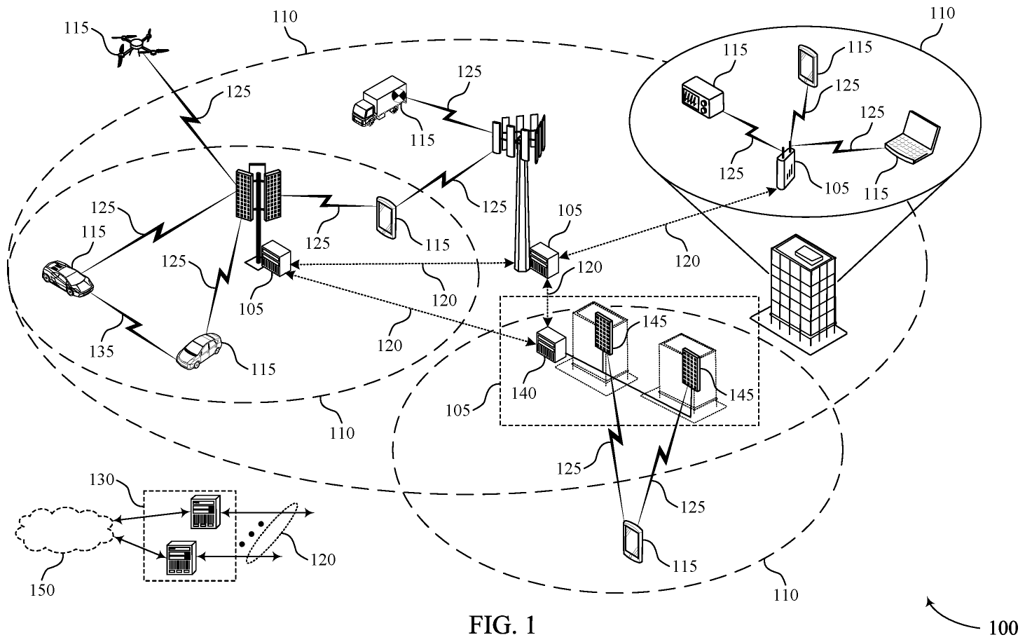

FIG. 1 illustrates an example of a wireless communications system 100 that supports techniques for BWP switching in accordance with aspects of the present disclosure. The wireless communications system 100 may include one or more network entities 105, one or more UEs 115, and a core network 130. In some examples, the wireless communications system 100 may be an LTE network, an LTE-A network, an LTE-A Pro network, or an NR network. In some examples, the wireless communications system 100 may support enhanced broadband communications, ultra-reliable communications, low latency communications, communications with low-cost and low-complexity devices, or any combination thereof.

The network entities 105 may be dispersed throughout a geographic area to form the wireless communications system 100 and may be devices in different forms or having different capabilities. The network entities 105 and the UEs 115 may wirelessly communicate via one or more communication links 125. Each network entity 105 may provide a coverage area 110 over which the UEs 115 and the network entity 105 may establish one or more communication links 125. The coverage area 110 may be an example of a geographic area over which a network entity 105 and a UE 115 may support the communication of signals according to one or more radio access technologies.

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115, the network entities 105, or network equipment (e.g., core network nodes, relay devices, integrated access and backhaul (IAB) nodes, or other network equipment), as shown in FIG. 1.

The network entities 105 may communicate with the core network 130, or with one another, or both. For example, the network entities 105 may interface with the core network 130 through one or more backhaul links 120 (e.g., via an S1, N2, N3, or other interface). The network entities 105 may communicate with one another over the backhaul links 120 (e.g., via an X2, Xn, or other interface) either directly (e.g., directly between network entities 105), or indirectly (e.g., via core network 130), or both. In some examples, the backhaul links 120 may be or include one or more wireless links.

One or more of the network entities 105 described herein may include or may be referred to by a person having ordinary skill in the art as a base transceiver station, a radio base station, an access point, a radio transceiver, a NodeB, an eNodeB (eNB), a next-generation NodeB or a giga-NodeB (either of which may be referred to as a gNB), a Home NodeB, a Home eNodeB, or other suitable terminology.

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay nodes, among other examples, as shown in FIG. 1.

The UEs 115 and the network entities 105 may wirelessly communicate with one another via one or more communication links 125 over one or more carriers. The term “carrier” may refer to a set of radio frequency spectrum resources having a defined physical layer structure for supporting the communication links 125. For example, a carrier used for a communication link 125 may include a portion of a radio frequency spectrum band (e.g., a BWP) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers.

In some examples (e.g., in a carrier aggregation configuration), a carrier may also have acquisition signaling or control signaling that coordinates operations for other carriers. A carrier may be associated with a frequency channel (e.g., an evolved universal mobile telecommunication system terrestrial radio access (E-UTRA) absolute radio frequency channel number (EARFCN)) and may be positioned according to a channel raster for discovery by the UEs 115. A carrier may be operated in a standalone mode where initial acquisition and connection may be conducted by the UEs 115 via the carrier, or the carrier may be operated in a non-standalone mode where a connection is anchored using a different carrier (e.g., of the same or a different radio access technology).

The communication links 125 shown in the wireless communications system 100 may include uplink transmissions from a UE 115 to a network entity 105, or downlink transmissions from a network entity 105 to a UE 115. Carriers may carry downlink or uplink communications (e.g., in an FDD mode) or may be configured to carry downlink and uplink communications (e.g., in a TDD mode).

A carrier may be associated with a particular bandwidth of the radio frequency spectrum, and in some examples the carrier bandwidth may be referred to as a “system bandwidth” of the carrier or the wireless communications system 100. For example, the carrier bandwidth may be one of a number of determined bandwidths for carriers of a particular radio access technology (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications over a particular carrier bandwidth or may be configurable to support communications over one of a set of carrier bandwidths. In some examples, the wireless communications system 100 may include network entities 105 or UEs 115 that support simultaneous communications via carriers associated with multiple carrier bandwidths. In some examples, each served UE 115 may be configured for operating over portions (e.g., a sub-band, a BWP) or all of a carrier bandwidth.

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may consist of one symbol period (e.g., a duration of one modulation symbol) and one subcarrier, where the symbol period and subcarrier spacing are inversely related. The number of bits carried by each resource element may depend on the modulation scheme (e.g., the order of the modulation scheme, the coding rate of the modulation scheme, or both). Thus, the more resource elements that a UE 115 receives and the higher the order of the modulation scheme, the higher the data rate may be for the UE 115. A wireless communications resource may refer to a combination of a radio frequency spectrum resource, a time resource, and a spatial resource (e.g., spatial layers or beams), and the use of multiple spatial layers may further increase the data rate or data integrity for communications with a UE 115.

One or more numerologies for a carrier may be supported, where a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, where Δfₘₐₓ may represent the maximum supported subcarrier spacing, and N_{f} may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a number of slots. Alternatively, each frame may include a variable number of slots, and the number of slots may depend on subcarrier spacing. Each slot may include a number of symbol periods (e.g., depending on the length of the cyclic prefix prepended to each symbol period). In some wireless communications systems 100, a slot may further be divided into multiple mini-slots containing one or more symbols. Excluding the cyclic prefix, each symbol period may contain one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., the number of symbol periods in a TTI) may be variable. Additionally or alternatively, the smallest scheduling unit of the wireless communications system 100 may be dynamically selected (e.g., in bursts of shortened TTIs (sTTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (e.g., a CORESET) for a physical control channel may be defined by a number of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to a number of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

In some examples, a network entity 105 may be movable and therefore provide communication coverage for a moving geographic coverage area 110. In some examples, different geographic coverage areas 110 associated with different technologies may overlap, but the different geographic coverage areas 110 may be supported by the same network entity 105. In other examples, the overlapping geographic coverage areas 110 associated with different technologies may be supported by different network entities 105. The wireless communications system 100 may include, for example, a heterogeneous network in which different types of the network entities 105 provide coverage for various geographic coverage areas 110 using the same or different radio access technologies.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a network entity 105 without human intervention. In some examples, M2M communication or MTC may include communications from devices that integrate sensors or meters to measure or capture information and relay such information to a central server or application program that makes use of the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception simultaneously). In some examples, half-duplex communications may be performed at a reduced peak rate. Other power conservation techniques for the UEs 115 include entering a power saving deep sleep mode when not engaging in active communications, operating over a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may also be able to communicate directly with other UEs 115 over a device-to-device (D2D) communication link 135 (e.g., using a peer-to-peer (P2P) or D2D protocol). One or more UEs 115 utilizing D2D communications may be within the geographic coverage area 110 of a network entity 105. Other UEs 115 in such a group may be outside the geographic coverage area 110 of a network entity 105 or be otherwise unable to receive transmissions from a network entity 105. In some examples, groups of the UEs 115 communicating via D2D communications may utilize a one-to-many (1:M) system in which each UE 115 transmits to every other UE 115 in the group. In some examples, a network entity 105 facilitates the scheduling of resources for D2D communications. In other cases, D2D communications are carried out between the UEs 115 without the involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

Some of the network devices, such as a network entity 105, may include subcomponents such as an access network entity 140, which may be an example of an access node controller (ANC). Each access network entity 140 may communicate with the UEs 115 through one or more other access network transmission entities 145, which may be referred to as radio heads, smart radio heads, or transmission/reception points (TRPs). Each access network transmission entity 145 may include one or more antenna panels. In some configurations, various functions of each access network entity 140 or network entity 105 may be distributed across various network devices (e.g., radio heads and ANCs) or consolidated into a single network device (e.g., a network entity 105).

The wireless communications system 100 may operate using one or more frequency bands, typically in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, but the waves may penetrate structures sufficiently for a macro cell to provide service to the UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHz.

The wireless communications system 100 may also operate in a super high frequency (SHF) region using frequency bands from 3 GHz to 30 GHz, also known as the centimeter band, or in an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105, and EHF antennas of the respective devices may be smaller and more closely spaced than UHF antennas. In some examples, this may facilitate use of antenna arrays within a device. The propagation of EHF transmissions, however, may be subject to even greater atmospheric attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed radio frequency spectrum bands. For example, the wireless communications system 100 may employ License Assisted Access (LAA), LTE-Unlicensed (LTE-U), or NR radio access technology in an unlicensed band such as the 5 GHz industrial, scientific, and medical (ISM) band. When operating in unlicensed radio frequency spectrum bands, devices such as the network entities 105 and the UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A network entity 105 or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more network entity antennas or antenna arrays may be co-located at an antenna assembly, such as an antenna tower. In some examples, antennas or antenna arrays associated with a network entity 105 may be located in diverse geographic locations. A network entity 105 may have an antenna array with a number of rows and columns of antenna ports that the network entity 105 may use to support beamforming of communications with a UE 115. Likewise, a UE 115 may have one or more antenna arrays that may support various MIMO or beamforming operations. Additionally, or alternatively, an antenna panel may support radio frequency beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beam forming operations. For example, a network entity 105 may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times in different directions. For example, the network entity 105 may transmit a signal according to different beamforming weight sets associated with different directions of transmission. Transmissions in different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by a network entity 105 in a single beam direction (e.g., a direction associated with the receiving device, such as a UE 115). In some examples, the beam direction associated with transmissions along a single beam direction may be determined based on a signal that was transmitted in one or more beam directions. For example, a UE 115 may receive one or more of the signals transmitted by the network entity 105 in different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or radio frequency beamforming to generate a combined beam for transmission (e.g., from a network entity 105 to a UE 115). The UE 115 may report feedback that indicates precoding weights for one or more beam directions, and the feedback may correspond to a configured number of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted in one or more directions by a network entity 105, a UE 115 may employ similar techniques for transmitting signals multiple times in different directions (e.g., for identifying a beam direction for subsequent transmission or reception by the UE 115) or for transmitting a signal in a single direction (e.g., for transmitting data to a receiving device).

A receiving device (e.g., a UE 115) may try multiple receive configurations (e.g., directional listening) when receiving various signals from the network entity 105, such as synchronization signals, reference signals, beam selection signals, or other control signals. For example, a receiving device may try multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned in a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or Packet Data Convergence Protocol (PDCP) layer may be IP-based. A Radio Link Control (RLC) layer may perform packet segmentation and reassembly to communicate over logical channels. A Medium Access Control (MAC) layer may perform priority handling and multiplexing of logical channels into transport channels. The MAC layer may also use error detection techniques, error correction techniques, or both to support retransmissions at the MAC layer to improve link efficiency. In the control plane, the Radio Resource Control (RRC) protocol layer may provide establishment, configuration, and maintenance of an RRC connection between a UE 115 and a network entity 105 or a core network 130 supporting radio bearers for user plane data. At the physical layer, transport channels may be mapped to physical channels.

The UEs 115 and the network entities 105 may support retransmissions of data to increase the likelihood that data is received successfully. Hybrid automatic repeat request (HARQ) feedback is one technique for increasing the likelihood that data is received correctly over a communication link 125. HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, where the device may provide HARQ feedback in a specific slot for data received in a previous symbol in the slot. In other cases, the device may provide HARQ feedback in a subsequent slot, or according to some other time interval.

The techniques described herein may enable a UE 115 to switch from a first BWP (which may be referred to as an active BWP) to a second BWP (which may be referred to as an initial BWP) to receive system information (e.g., from a network entity 105) for a carrier that includes the first and second BWPs. The UE 115 may switch to the second BWP to receive system information based on a trigger (e.g., control signaling or an expiration of a timer) and then switch back to the first BWP without additional signaling to continue operation. In some examples, the UE 115 may receive additional signaling (e.g., data, control signaling, reference signals) in the second BWP. In some examples, a BWP switching duration may include additional time to process the system information received in the second BWP, for example if the system information or other signaling includes instructions to switch to a third BWP (e.g., rather than returning to the first BWP).

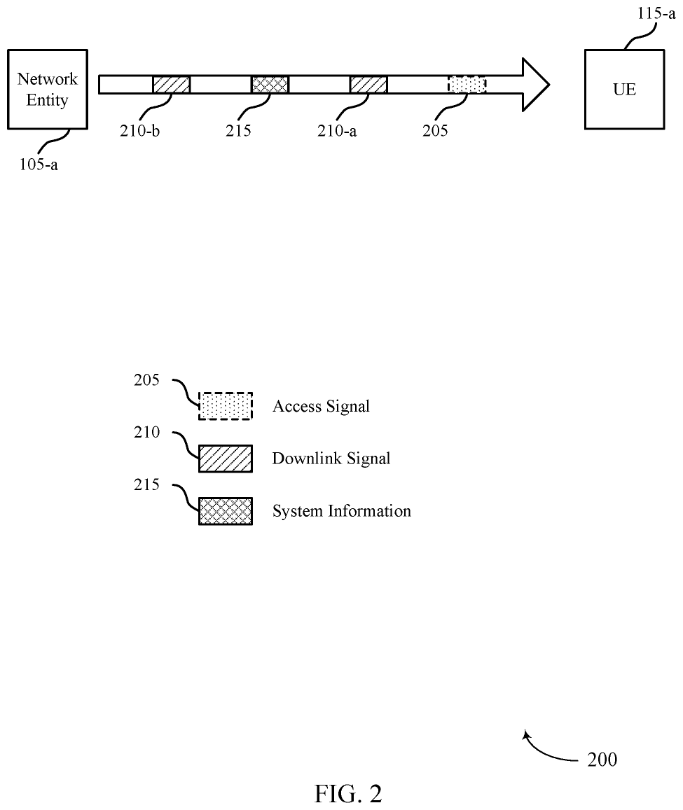

FIG. 2 illustrates an example of a wireless communications system 200 that supports techniques for BWP switching in accordance with aspects of the present disclosure. In some examples, the wireless communications system 200 may implement aspects of the wireless communications system 100. For example, the wireless communications system 200 may include a network entity 105-a and a UE 115-a, which may be examples of the corresponding devices described with reference to FIG. 1. In some examples, the UE 115-a may have reduced capabilities (e.g., bandwidth capabilities, beamforming capabilities, among other examples) compared to other UEs 115 in the wireless communications system 200. The wireless communications system 200 may include features for improved communications between the UE 115-a and the network entity 105-a, among other benefits.

The UE 115-a may operate in a first BWP of a carrier, which may be referred to as an active BWP. The first BWP may be smaller (e.g., include less frequency resources) than a full bandwidth of the carrier, and may be smaller than bandwidths of BWPs of other UEs 115 may use in the wireless communications system 200. In some cases, the UE 115-a may receive an access signal 205 in a second BWP, which may be referred to as an initial BWP. The access signal 205 may indicate an access configuration for operating on the carrier. After receiving the access signal 205, the UE 115-a may switch to operating in the first BWP (e.g., according to a configuration for operating in an active BWP corresponding to the first BWP), which may include receiving one or more downlink signals 210, such as control signals or data signals.

In some cases, the second BWP (e.g., the initial BWP) may include frequency resources allocated by the network entity 105-a for transmitting synchronization signals, system information 215, or reference signals. It may be beneficial to establish an efficient timeline for the UE 115-a to switch to the second BWP to receive the signaling and switch back to operation in the first BWP.

As described herein, the UE 115-a may switch to the second BWP to receive the system information 215 based on a trigger, such as control signal or an expiration of a timer at the UE 115-a. In some examples, the UE 115-a may receive the control signal in a downlink signal 210-a (e.g., in the first BWP). In some examples, the control signal may be an RRC message, a MAC-CE, or a DCI message (e.g., a paging DCI, where the DCI message may be scrambled using a paging radio network temporary identifier (P-RNTI)). In some examples, the UE 115-a may receive additional signaling in the second BWP, such as one or more reference signals (e.g., an SSB or a CSI-RS), a downlink signal 210, paging information, or any combination thereof.

After receiving the system information 215, the UE 115-a may switch to the first BWP to continue operations, which may include receiving a downlink signal 210-b. In some examples, the UE 115-a may switch to a third BWP after receiving the system information 215 in the second BWP. In some examples, the control signal may schedule the switch to the second BWP as well as the switch to the first BWP (or the third BWP). Additionally, or alternatively, the switch from the second BWP may be based on a scheduling parameter associated with receiving the system information 215. For example, the scheduling parameter may correspond to a system information modification boundary or a system information window, which may include a duration in which the UEs 115 in the wireless communications system 200 are configured to monitor for the system information 215.

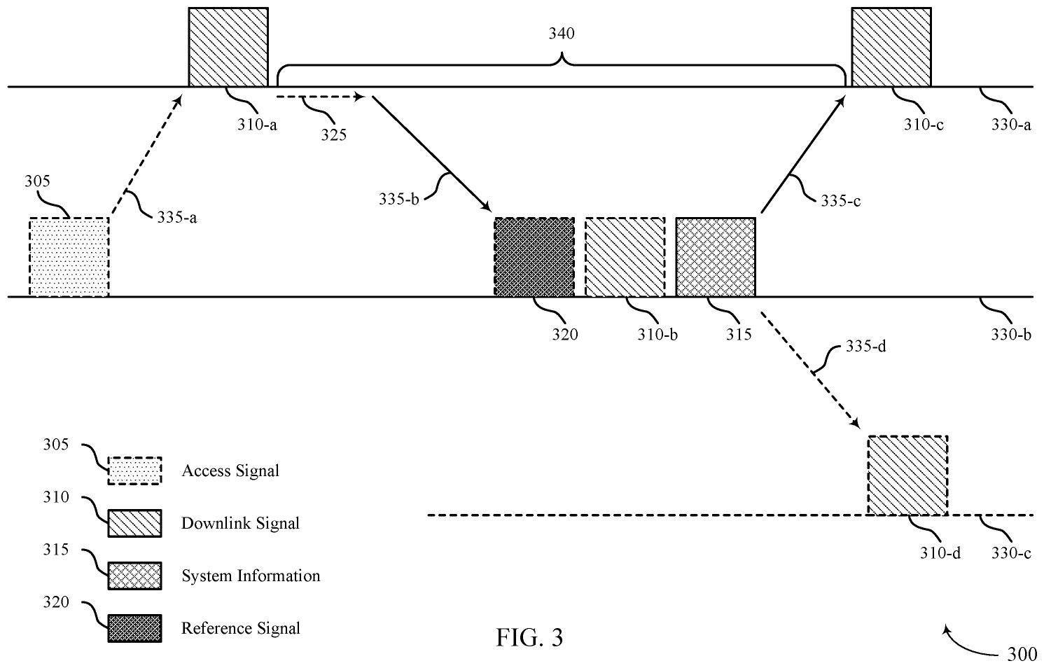

FIG. 3 illustrates an example of a transmission scheme 300 that supports techniques for BWP switching in accordance with aspects of the present disclosure. In some examples, the transmission scheme 300 may implement aspects of the wireless communications system 100 or the wireless communications system 200. For example, the transmission scheme 300 may illustrate communication between devices in a wireless communications system, each of which may be an example of a UE 115 or a network entity 105 described with reference to FIGS. 1 and 2. The transmission scheme 300 may include features for improved communication reliability, among other benefits.

A UE may be configured to operate on a carrier to communicate with a network entity, where the carrier may include one or more BWPs 330. In some examples, the UE may have reduced capabilities (e.g., bandwidth capabilities, beamforming capabilities, among other examples) compared to other UEs. For example, the UE may be configured to communicate in a BWP 330-a (which may be referred to as an active BWP 330-a of the UE) that is smaller than the overall BWP 330 of the carrier. The BWP 330-a may not include a BWP 330-b (which may be referred to as an initial BWP 330-b), where the BWP 330-b may include frequency resources allocated by the network entity for transmitting system information 315. In some cases, the UE may receive an access signal 305 in the BWP 330-b, where the access signal 305 may indicate an access configuration for operating on the carrier. After receiving the access signal 305, the UE may perform a switch 335-a to operate in the BWP 330-a.

As described herein, the UE may switch to the BWP 330-b to receive the system information 315 based on a trigger, such as a control signal or an expiration of a timer at the UE. In some examples, the UE may receive the control signal in a downlink signal 310-a (e.g., in the BWP 330-a). In some examples, the control signal may be an RRC message, a MAC-CE, or a DCI message (e.g., a paging DCI, where the DCI message may be scrambled using a P-RNTI). Based on the trigger, the UE may perform a switch 335-b to operate in the BWP 330-b to receive the system information 315. In some examples, the UE may wait a duration 325 before performing the switch 335-b, for example to align the switch 335-b with a system information reception opportunity, which in some cases may be referred to as a system information modification boundary or a system information window. In some examples, if a gap between receiving the control signal and a system information modification boundary is less than a configured gap (e.g., a minimum gap, which may be referred to as t0), the UE may perform the switch 335-b at a subsequent system information modification boundary.

In some examples, the switching timeline to perform the switch 335-b may be based on one or more parameters, such as a UE capability, a frequency range of the carrier (e.g., including a respective frequency range of one or both of the BWPs 330-a and 330-b), a subcarrier spacing (SCS) of the carrier, or any combination thereof. In some examples, the UE capability may include a quantity of phase locked loops (PLLs) at the UE. For example, if the UE has two PLLs available for tracking signals, the UE may use a first PLL to track signals in the BWP 330-a and a second PLL to track signals in the BWP 330-b, and the switching timeline to perform the switch 335-b may be relatively short. Alternatively, if the UE has a single PLL, the switching timeline to perform the switch 335-b may be relatively long, where performing the switch 335-b may include adjusting the PLL to stop signal tracking in the BWP 330-a and initiate signal tracking in the BWP 330-b. Additionally, or alternatively, the UE capability may include a duplexing mode capability. For example, if the UE is capable of full-duplex FDD (e.g., a mode that supports concurrent transmission and reception), the switching timeline to perform the switch 335-b may be relatively short (e.g., the switch 335-b may be nearly instantaneous). Alternatively, if the UE is capable of half-duplex FDD, the switching timeline to perform the switch 335-b may be longer than the switching timeline for a UE capable of full-duplex FDD.

After the switch 335-b, the UE may monitor for signaling in the BWP 330-b, including the system information 315. The UE may receive the system information 315 in one or more SIBs, including a MIB, a SIB1, a SIB2, a SIB3, a SIB that contains a position reference signal or related information (which may be referred to as a posSIB), OSI, etc. In some examples, the control signal (e.g., the paging DCI) may indicate which SIBs are being updated in the system information reception opportunity. For example, the control signal may indicate (e.g., in a bit field) that the MIB, the MIB and SIB1, or OSI will be updated. That is, each bit of a bit field may indicate one or more groups of SIBs that are being updated in the system information reception opportunity. Additionally, or alternatively, the control signal may explicitly indicate each SIB that will be updated (e.g., SIB2, SIB3, etc.). Additionally, or alternatively, the control signal may include a flag to indicate one or more targets of the updated system information 315. For example, the flag may identify a UE type (e.g., UEs with reduced capability, IoT UEs, among other examples) associated with the updated system information 315. The UE may perform the switch 335-b to receive the updated SIBs based on identifying in the control signal the UE type and SIBs to be updated.

In some examples, the UE may receive, along with the system information 315, additional signaling in the BWP 330-b. For example, the UE may receive a downlink signal 310-b, which may include a control signal (e.g., in a physical downlink control channel (PDCCH)) or a data signal (e.g., in a physical downlink shared channel (PDSCH), which may also include the control signal). Additionally, or alternatively, the UE may receive one or more reference signals 320, which may include an SSB, a CSI-RS, or both. In some examples, the downlink signal 310-b may have a QCL relationship with the reference signals 320. In some examples, the combination of the control signal and the data signal in the downlink signal 310-b may include the system information 315, paging information, or both. In some examples, the switching timeline to perform the switch 335-b may include the time to receive the reference signals 320.

After receiving the signaling in the BWP 330-b, the UE may perform a switch 335-c to return to operating in the BWP 330-a (e.g., to receive a downlink signal 310-c), or the UE may perform a switch 335-d to operate in a BWP 330-c (e.g., to receive a downlink signal 310-d). In some examples, the control signal in the downlink signal 310-a may configure the switch 335-c or the switch 335-d. In some examples, a switching timeline to perform the switch 335-c or the switch 335-d may have a different length than the switching timeline to perform the switch 335-b. For example, the UE may have more time to prepare for the switch 335-c or the switch 335-d, and so the switching timeline to perform the switch 335-c or the switch 335-d may be shorter than the switching timeline to perform the switch 335-b. In some examples, the switching timeline to perform the switch 335-c (e.g., to return to operating in the BWP 330-a) may be shorter than the switching timeline to perform the switch 335-d (e.g., to operate in the BWP 330-c). In some examples, the switching timeline to perform the switch 335-c or the switch 335-d may include additional time to process the reference signals 320 or the system information 315. For example, a processing time for the reference signals 320 (e.g., SSB) may be a first fixed processing time (e.g., 2 ms), and a processing time for the system information (which may be referred to as a UE processing time or an RRC processing time) may be a second fixed processing time (e.g., 10 ms). Additionally, or alternatively, the processing times may be configured based on the UE capability.

In some examples, the network entity may configure a measurement gap 340 for the UE, where the measurement gap may include the duration 325, the switches 335, the time spent receiving signaling in the BWP 330-b, and the processing times. The UE may not be required to receive or transmit signaling in the BWP 330-a in the measurement gap 340. The network entity may restrict scheduling such that the UE is not scheduled to receive or transmit signaling in the BWP 330-a in the measurement gap 340. Additionally, or alternatively, the UE may be configured to not measure or transmit signaling during the switches 335. In some examples, the measurement gap 340 may be a time to perform the switch 335-b (which may be referred to as T_{BWPswitchDelay} or T_{BWPswitchDelay_1}), a time to receive the system information 315 (which may be referred to as T_{S1_acquisition}), a time to perform the switch 335-c or the switch 335-d (which may be referred to as T_{BWPswitchDelay} or T_{BWPswitchDelay_2}), a time to receive the reference signals 320 (which may be referred to as k*T_{SSB,Period}, where k is the quantity of SSB samples received to decode the system information 315), a processing time to process the reference signals 320 (which may be referred to as T_{SSB,Proc}), and a processing time to process the system information 315 (which may be referred to as T_{RRC,Processing}).

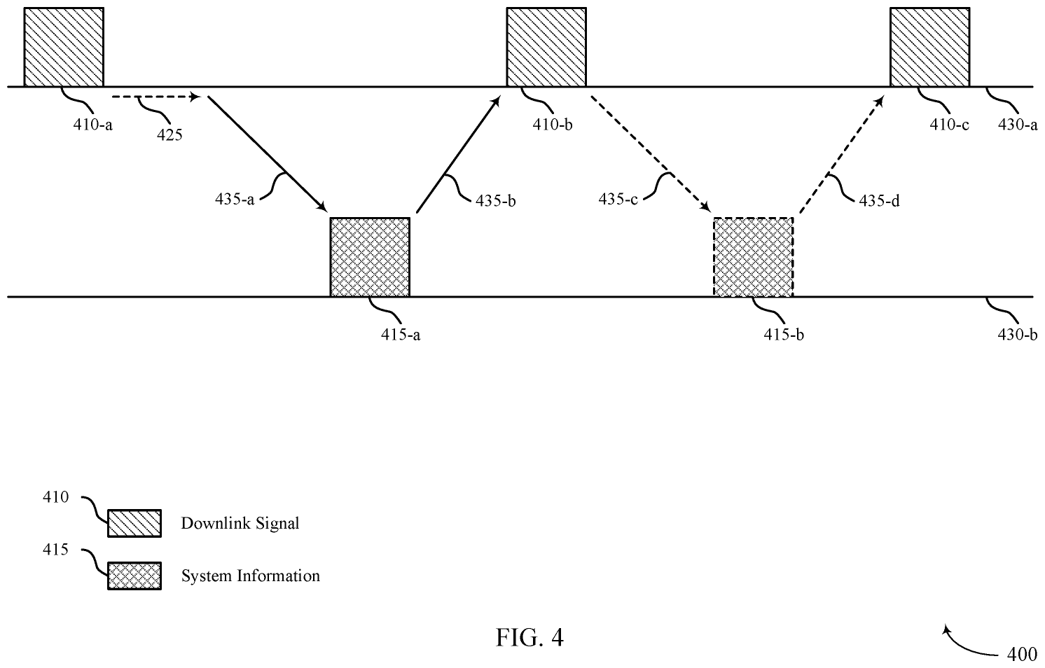

FIG. 4 illustrates an example of a transmission scheme 400 that supports techniques for BWP switching in accordance with aspects of the present disclosure. In some examples, the transmission scheme 400 may implement aspects of the wireless communications system 100 or the wireless communications system 200. For example, the transmission scheme 400 may illustrate communication between devices in a wireless communications system, each of which may be an example of a UE 115 or a network entity 105 described with reference to FIGS. 1 and 2. The transmission scheme 400 may include features for improved communication reliability, among other benefits.

A UE may be configured to operate on a carrier to communicate with a network entity, where the carrier may include one or more BWPs 430. In some examples, the UE may have reduced capabilities (e.g., bandwidth capabilities, beamforming capabilities, among other examples) compared to other UEs. For example, the UE may be configured to communicate in a BWP 430-a (which may be referred to as an active BWP 430-a of the UE) that is smaller than the overall BWP 430 of the carrier. The BWP 430-a may not include a BWP 430-b (which may be referred to as an initial BWP 430-b), where the BWP 430-b may include frequency resources allocated by the network entity for transmitting system information 415.

As described herein, the UE may switch to the BWP 430-b to receive system information 415 based on a trigger, such as a control signal or an expiration of a timer at the UE. In some examples, the UE may receive the control signal in a downlink signal 410-a (e.g., in the BWP 430-a). In some examples, the control signal may be an RRC message, a MAC-CE, or a DCI message (e.g., a paging DCI, where the DCI message may be scrambled using a P-RNTI). Based on the trigger, the UE may perform a switch 435-a to operate in the BWP 430-b to receive system information 415-a. In some examples, the UE may wait a duration 425 before performing the switch 435-a, for example to align the switch 435-a with a system information reception opportunity, which in some cases may be referred to as a system information modification boundary or a system information window. In some examples, if a gap between receiving the control signal and a system information modification boundary is less than a configured gap (e.g., a minimum gap, which may be referred to as t0), the UE may perform the switch 435-a at a subsequent system information modification boundary.

After the switch 435-a, the UE may monitor for signaling in the BWP 430-b, including the system information 415-a. The UE may receive the system information 415-a in one or more SIBs, including a MIB, a SIB1, a SIB2, a SIB3, a posSIB, OSI, etc. In some examples, the control signal (e.g., the paging DCI) may indicate which SIBs are being updated in the system information reception opportunity. For example, the control signal may indicate (e.g., in a bit field) that the MIB, the MIB and SIB1, or OSI will be updated. That is, each bit of a bit field may indicate one or more groups of SIBs that are being updated in the system information reception opportunity. Additionally, or alternatively, the control signal may explicitly indicate each SIB that will be updated (e.g., SIB2, SIB3, etc.). Additionally, or alternatively, the control signal may include a flag to indicate one or more targets of the updated system information 415-a. For example, the flag may identify a UE type (e.g., UEs with reduced capability, IoT UEs, among other examples) associated with the updated system information 415-a. The UE may perform the switch 435-a to receive the updated SIBs based on identifying in the control signal the UE type and SIBs to be updated.

After receiving the signaling in the BWP 430-b, the UE may perform a switch 435-b to return to operating in the BWP 430-a, and monitor for a downlink signal 410-b. In some examples, the UE may perform a switch 435-c to receive system information 415-b in the BWP 430-b. The system information 415-b may include additional SIBs, repetitions of the SIBs in the system information 415-a, or both. In some examples, the UE may perform the switch 435-b, receive the downlink signal 410-b, and perform the switch 435-c (where these steps may be collectively referred to as a “ping-pong” between the BWPs 430-a and 430-b) to improve throughput, rather than remaining in the BWP 430-b to receive the system information 415-a and the system information 415-b without returning to the BWP 430-a. In some examples, the UE may determine whether to ping-pong or remain in the BWP 430-b between receiving the system information 415-a and receiving the system information 415-b based on a quantity of available slots (e.g., available for receiving a downlink signal 410) between a first search space associated with the system information 415-a and a second search space associated with the system information 415-b. For example, the UE may determine to remain in the BWP 430-b if the quantity of available slots does not satisfy a threshold quantity of slots. Additionally, or alternatively, the UE may determine whether to ping-pong or remain in the BWP 430-b based on a respective scheduling offset (which may be referred to as KO) associated with each of the first search space and the second search space. For example, the UE may determine a quantity of available slots based on assuming each PDSCH containing SIBs of the system information 415-a and the system information 415-b is scheduled with a maximum scheduling offset in each search space. In some examples, the network entity may send values for the UE to use in determining whether to ping-pong (e.g., the threshold quantity of slots, a value to use for KO). Alternatively, the UE may signal values that the UE will use in determining whether to ping-pong (e.g., the threshold quantity of slots, a value to use for KO) to the network entity. Based on the configured values, the network entity may determine whether the UE will ping-pong or remain in the BWP 430-b, and schedule downlink signals 410 accordingly.

In some examples, after performing the switch 435-b to operate in the BWP 430-a, the UE may transmit an uplink signal (e.g., in a physical uplink control channel (PUCCH) or a physical uplink shared channel (PUSCH)) to the network entity. The uplink signal may indicate to the network entity that the UE has finished reading the system information 415-a and will not perform the switch 435-c to receive the system information 415-b, or the uplink signal may indicate that the UE will perform the switch 435-c to receive the system information 415-b. In some examples, after receiving the system information 415-b, the UE may perform a switch 435-d to return to operating in the BWP 430-a, and monitor for a downlink signal 410-c.

In some examples, after performing the switch 435-b to operate in the BWP 430-a, the UE may determine that a beam quality in the BWP 430-a has deteriorated (e.g., fallen below a beam quality threshold). Based on the beam quality, the UE may declare a beam failure and transmit a signal indicating a beam failure recovery procedure. Based on transmitting the signal indicating the beam failure recovery procedure, the UE may skip performing the switch 435-c to receive the system information 415-b in the BWP 430-b. Additionally or alternatively, if the UE determines that a beam quality in the BWP 430-a has deteriorated prior to the switch 435-a, the UE may skip performing the switch 435-a to transmit a signal indicating a beam failure recovery procedure.

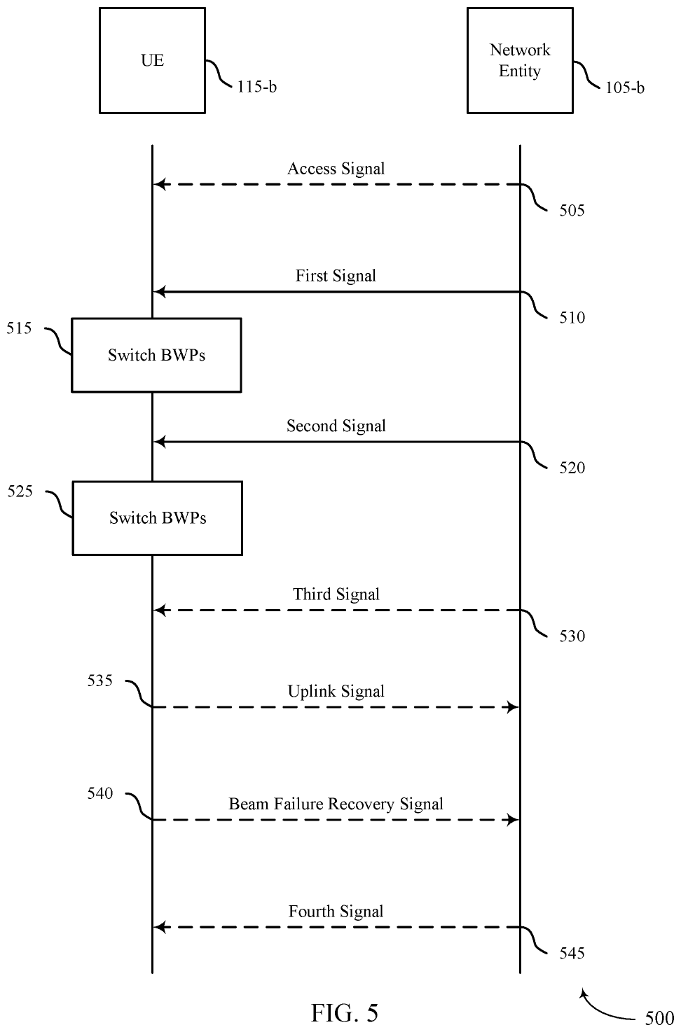

FIG. 5 illustrates an example of a process flow 500 that supports techniques for BWP switching in accordance with aspects of the present disclosure. In some examples, the process flow 500 may implement aspects of wireless communications systems 100 and 200. For example, the process flow 500 may include example operations associated with one or more of a network entity 105-b or a UE 115-b, which may be examples of the corresponding devices described with reference to FIGS. 1 and 2. In the following description of the process flow 500, the operations between the network entity 105-b and the UE 115-b may be performed in a different order than the example order shown, or the operations performed by the network entity 105-b and the UE 115-b may be performed in different orders or at different times. Some operations may also be omitted from the process flow 500, and other operations may be added to the process flow 500. The operations performed by the network entity 105-b and the UE 115-b may support improvement to the UE 115-b network access operations and, in some examples, may promote improvements to efficiency and reliability for communications between the network entity 105-b and the UE 115-b, among other benefits.

In some examples, the UE 115-b may have reduced capabilities (e.g., bandwidth capabilities, beamforming capabilities, among other examples) compared to other UEs 115. For example, the UE 115-b may be configured to communicate in a first BWP (which may be referred to as an active BWP of the UE 115-b) that is smaller than the overall BWP of a carrier. The first BWP may not include a second BWP (which may be referred to as an initial BWP), where the second BWP may include frequency resources allocated by the network entity for transmitting system information.

In some cases, at 505 the UE 115-b may receive an access signal in the second BWP, where the access signal may indicate an access configuration for operating on the carrier. After receiving the access signal, the UE 115-b may perform a switch to operate in the first BWP.

At 510, the network entity 105-b may transmit a first signal to the UE 115-b. In some examples, the first signal may include a control signal or a message indicating the UE 115-b is to switch to the second BWP to receive system information (e.g., updated system information). In some examples, the control signal may be an RRC message, a MAC-CE, or a DCI message (e.g., a paging DCI, where the DCI message may be scrambled using a P-RNTI).

At 515, the UE 115-b may switch BWPs. For example, the UE 115-b may switch from the first BWP to the second BWP based at least in part on an RRC message, a MAC-CE, or a DCI message, indicating for the UE 115-b to switch to the second BWP to receive system information (e.g., updated system information).

At 520, the UE 115-b may receive a second signal in the second BWP, for example after switching to operate in the second BWP. The UE 115-b may switch to operate in the second BWP based on a trigger indicating the switch (e.g., the control signal or the message in the first signal, or an expiration of a timer at the UE 115-b). In some examples, the UE 115-b may wait a duration before performing the switch, for example to align the switch with a system information reception opportunity, which in some cases may be referred to as a system information modification boundary or a system information window. In some examples, if a gap between receiving the control signal and a system information modification boundary is less than a configured gap (e.g., a minimum gap, which may be referred to as t0), the UE 115-b may perform the switch at a subsequent system information modification boundary.

In some examples, the switching timeline to perform the switch may be based on one or more parameters, such as a UE capability, a frequency range of the carrier (e.g., including a respective frequency range of one or both of the first and second BWPs), an SCS of the carrier, or any combination thereof. In some examples, the UE capability may include a quantity of PLLs at the UE 115-b. Additionally, or alternatively, the UE 115-b capability may include a duplexing mode capability.

The second signal may include system information for the carrier, a paging message, or both. In some examples, the UE 115-b may receive the system information in one or more SIBs, including a MIB, a SIB1, a SIB2, a SIB3, a posSIB, OSI, etc. In some examples, the control signal may indicate which SIBs are being updated in the system information reception opportunity. Additionally, or alternatively, the control signal may include a flag to indicate one or more targets of the updated system information. For example, the flag may identify a UE type associated with the updated system information. The UE 115-b may perform the switch to receive the updated SIBs based on identifying in the control signal the UE type and SIBs to be updated.

In some examples, the UE 115-b may receive, along with the system information, additional signaling in the second BWP. For example, the UE 115-b may receive a downlink signal, which may include a control signal or a data signal. Additionally, or alternatively, the UE 115-b may receive one or more reference signals, which may include an SSB, a CSI-RS, or both. In some examples, the downlink signal may have a QCL relationship with the reference signals. In some examples, the switching timeline to perform the switch to operating in the second BWP may include the time to receive the reference signals.

At 525, after receiving the signaling in the second BWP, the UE 115-b may switch BWPs. For example, after receiving the signaling in the second BWP, the UE 115-b may perform a switch to return to operating in the first BWP or the UE 115-b may perform a switch to operate in a third BWP. In some examples, the control signal in the first signal may configure the switch.

At 530, the network entity 105-b may transmit a third signal to the UE 115-b in the first BWP or the third BWP. The third signal may include a control signal or a data signal.

In some examples, at 535, the UE 115-b may transmit an uplink signal to the network entity 105-b. The uplink signal may indicate to the network entity 105-b that the UE 115-b has finished reading the system information, or the uplink signal may indicate that the UE 115-b is in a ping-pong state, and will perform a switch to receive second system information in the second BWP.

In some examples, at 540, the UE 115-b may transmit a beam failure recover signal. For example, the UE 115-b may determine that a beam quality in the first BWP has deteriorated (e.g., fallen below a beam quality threshold). Based on the beam quality, the UE 115-b may declare a beam failure and transmit a signal indicating a beam failure recovery procedure. Based on transmitting the signal indicating the beam failure recovery procedure, the UE 115-b may skip performing the switch to receive second system information in the second BWP.

In some examples, at 545 the network entity 105-b may transmit a fourth signal to the UE 115-b in the second BWP. The fourth signal may include second system information, which may include additional SIBs, repetitions of the SIBs in the first system information, or both. By implementing one or more of the described techniques for BWP switching, the UE 115-b and the network entity 105-b may be able to communicate more reliably, among other benefits.

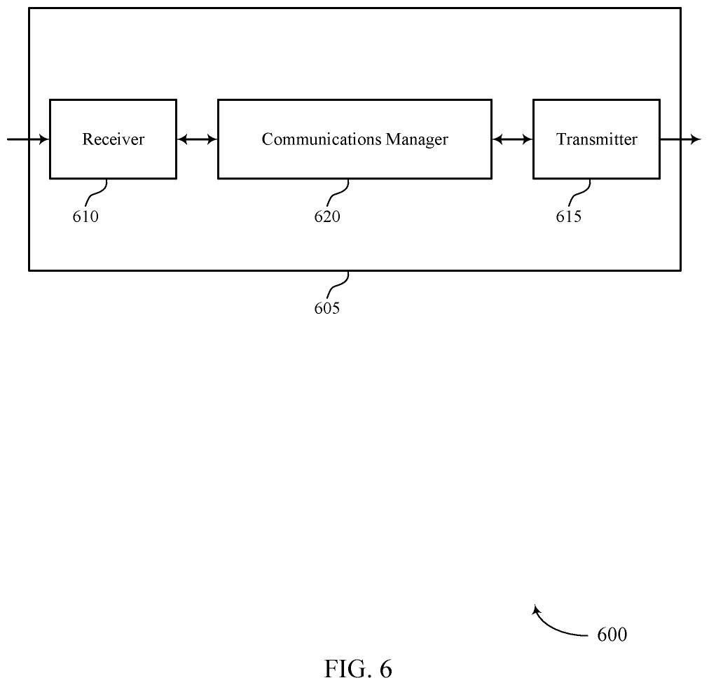

FIG. 6 shows a block diagram 600 of a device 605 that supports techniques for BWP switching in accordance with aspects of the present disclosure. The device 605 may be an example of aspects of a UE 115 as described herein. The device 605 may include a receiver 610, a transmitter 615, and a communications manager 620. The device 605 may also include a processor. Each of these components may be in communication with one another (e.g., via one or more buses).

The receiver 610 may provide a means for receiving information such as packets, user data, control information, or any combination thereof associated with various information channels (e.g., control channels, data channels, information channels related to techniques for BWP switching). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to techniques for BWP switching). In some examples, the transmitter 615 may be co-located with a receiver 610 in a transceiver module. The transmitter 615 may utilize a single antenna or a set of multiple antennas.

The communications manager 620, the receiver 610, the transmitter 615, or various combinations thereof or various components thereof may be examples of means for performing various aspects of techniques for BWP switching as described herein. For example, the communications manager 620, the receiver 610, the transmitter 615, or various combinations or components thereof may support a method for performing one or more of the functions described herein.

In some examples, the communications manager 620, the receiver 610, the transmitter 615, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 620, the receiver 610, the transmitter 615, or various combinations or components thereof may be implemented in code (e.g., as communications management software or firmware) executed by a processor. If implemented in code executed by a processor, the functions of the communications manager 620, the receiver 610, the transmitter 615, or various combinations or components thereof may be performed by a general-purpose processor, a DSP, a central processing unit (CPU), an ASIC, an FPGA, or any combination of these or other programmable logic devices (e.g., configured as or otherwise supporting a means for performing the functions described in the present disclosure).

In some examples, the communications manager 620 may be configured to perform various operations (e.g., receiving, monitoring, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to receive information, transmit information, or perform various other operations as described herein.

The communications manager 620 may support wireless communication at a UE in accordance with examples as disclosed herein. For example, the communications manager 620 may be configured as or otherwise support a means for monitoring for a first signal in a first BWP of a carrier. The communications manager 620 may be configured as or otherwise support a means for receiving a second signal in a second BWP of the carrier based on a trigger indicating that the UE is to receive the second signal in the second BWP, the second signal including system information for the carrier, a paging message, or both.

By including or configuring the communications manager 620 in accordance with examples as described herein, the device 605 (e.g., a processor controlling or otherwise coupled to the receiver 610, the transmitter 615, the communications manager 620, or a combination thereof) may support techniques for reduced processing, reduced power consumption, or more efficient utilization of communication resources.

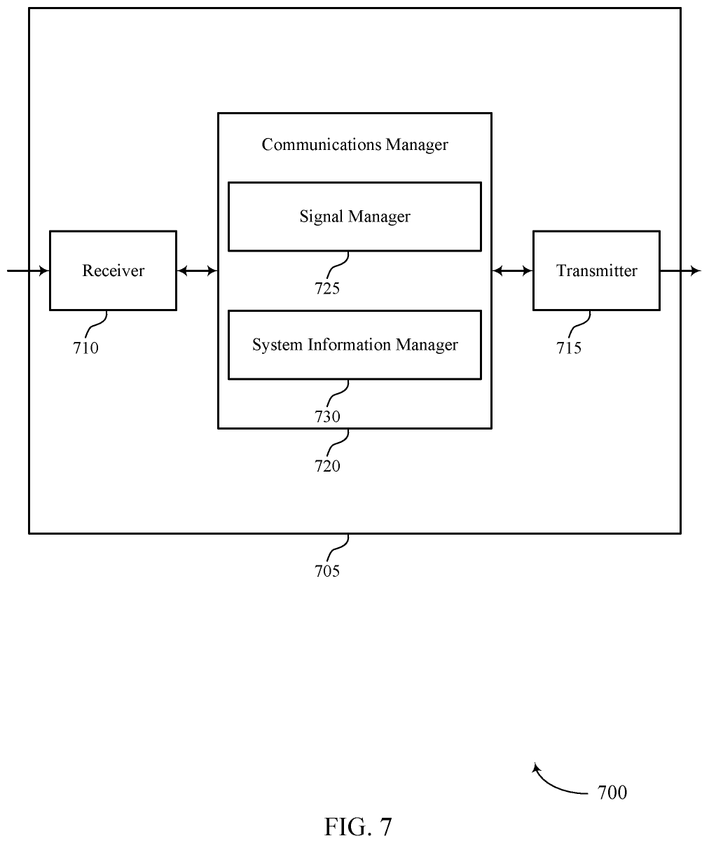

FIG. 7 shows a block diagram 700 of a device 705 that supports techniques for BWP switching in accordance with aspects of the present disclosure. The device 705 may be an example of aspects of a device 605 or a UE 115 as described herein. The device 705 may include a receiver 710, a transmitter 715, and a communications manager 720. The device 705 may also include a processor. Each of these components may be in communication with one another (e.g., via one or more buses).

The receiver 710 may provide a means for receiving information such as packets, user data, control information, or any combination thereof associated with various information channels (e.g., control channels, data channels, information channels related to techniques for BWP switching). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to techniques for BWP switching). In some examples, the transmitter 715 may be co-located with a receiver 710 in a transceiver module. The transmitter 715 may utilize a single antenna or a set of multiple antennas.

The device 705, or various components thereof, may be an example of means for performing various aspects of techniques for BWP switching as described herein. For example, the communications manager 720 may include a signal manager 725 a system information manager 730, or any combination thereof. The communications manager 720 may be an example of aspects of a communications manager 620 as described herein. In some examples, the communications manager 720, or various components thereof, may be configured to perform various operations (e.g., receiving, monitoring, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to receive information, transmit information, or perform various other operations as described herein.

The communications manager 720 may support wireless communication at the device 705 (e.g., a UE) in accordance with examples as disclosed herein. The signal manager 725 may be configured as or otherwise support a means for monitoring for a first signal in a first BWP of a carrier. The system information manager 730 may be configured as or otherwise support a means for receiving a second signal in a second BWP of the carrier based on a trigger indicating that the UE is to receive the second signal in the second BWP, the second signal including system information for the carrier, a paging message, or both.

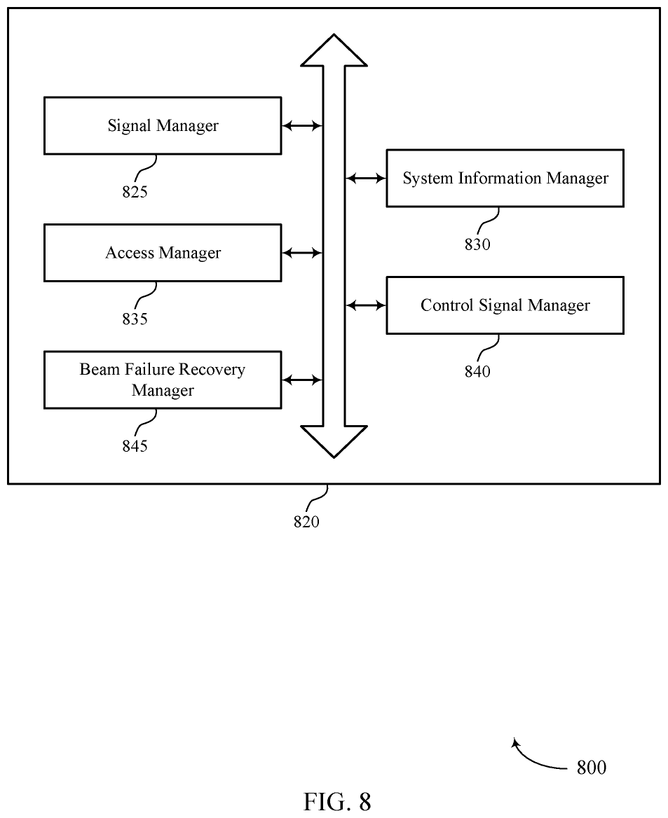

FIG. 8 shows a block diagram 800 of a communications manager 820 that supports techniques for BWP switching in accordance with aspects of the present disclosure. The communications manager 820 may be an example of aspects of a communications manager 620, a communications manager 720, or both, as described herein. The communications manager 820, or various components thereof, may be an example of means for performing various aspects of techniques for BWP switching as described herein. For example, the communications manager 820 may include a signal manager 825, a system information manager 830, an access manager 835, a control signal manager 840, a beam failure recovery manager 845, or any combination thereof. Each of these components may communicate, directly or indirectly, with one another (e.g., via one or more buses).

The communications manager 820 may support wireless communication at a UE in accordance with examples as disclosed herein. The signal manager 825 may be configured as or otherwise support a means for monitoring for a first signal in a first BWP of a carrier. The system information manager 830 may be configured as or otherwise support a means for receiving a second signal in a second BWP of the carrier based on a trigger indicating that the UE is to receive the second signal in the second BWP, the second signal including system information for the carrier, a paging message, or both. In some examples, the signal manager 825 may be configured as or otherwise support a means for monitoring for a third signal in a third BWP of the carrier based on a scheduling parameter associated with receiving the second signal.

In some examples, the access manager 835 may be configured as or otherwise support a means for receiving, prior to monitoring for the first signal in the first BWP, signaling in the second BWP, where the signaling indicates an access configuration for operating on the carrier, where monitoring for the first signal in the first BWP is based on receiving the signaling.

In some examples, the control signal manager 840 may be configured as or otherwise support a means for receiving a control signal, where the trigger indicating that the UE is to receive the second signal in the second BWP includes the control signal. In some examples, the control signal further indicates a switch from the second BWP to the third BWP. In some examples, the control signal includes the scheduling parameter associated with receiving the second signal. In some examples, the control signal includes a DCI message, a MAC-CE, a RRC message, or any combination thereof. In some examples, the DCI message may be scrambled using a P-RNTI.

In some examples, the trigger indicating that the UE is to receive the second signal in the second BWP includes an expiration of a timer. In some examples, each of a first switch duration corresponding to switching from the first BWP to the second BWP and a second switch duration corresponding to switching from the second BWP to the third BWP is based on a subcarrier spacing of the carrier, a frequency range of the carrier, a UE capability parameter, or any combination thereof. In some examples, the UE capability parameter includes a duplexing mode parameter, a quantity of phase locked loops associated with tracking signals at the UE, or both.

In some examples, a first switch duration corresponding to switching from the first BWP to the second BWP, a duration corresponding to receiving the second signal in the second BWP, a second switch duration corresponding to switching from the second BWP to the third BWP, or any combination thereof, correspond to a scheduled measurement gap. In some examples, the signal manager 825 may be configured as or otherwise support a means for refraining from monitoring for signaling in the first BWP in the scheduled measurement gap.

In some examples, a first switch duration corresponding to switching from the first BWP to the second BWP is based on one or more reference signals associated with receiving signaling in the second BWP. In some examples, the second signal has a QCL relationship with the one or more reference signals. In some examples, a second switch duration corresponding to switching from the second BWP to the third BWP is based on one or more reference signals associated with receiving signaling in the third BWP. In some examples, the third signal has a QCL relationship with the one or more reference signals. In some examples, the second switch duration is further based on a first processing duration associated with processing the one or more reference signals, a second processing duration associated with processing the second signal, or both. In some examples, a first switch duration corresponding to switching from the first BWP to the second BWP is different than a second switch duration corresponding to switching from the second BWP to the third BWP. In some examples, the second switch duration is less than the first switch duration.

In some examples, the second signal further includes a control signal, a data signal, or both. In some examples, the second signal has a QCL relationship with one or more reference signals associated with receiving signaling in the second BWP. In some examples, the one or more reference signals include an SSB, a CSI-RS, or both. In some examples, the system information for the carrier includes one or more SIBs. In some examples, a SIB of the one or more system information blocks includes a position reference signal. In some examples, the first BWP and the third BWP are a same BWP.

In some examples, the signal manager 825 may be configured as or otherwise support a means for receiving, in the first signal, a message indicating that the UE is to receive updated system information, where the trigger indicating that the UE is to receive the second signal in the second BWP includes the message in the first signal.

In some examples, the message in the first signal includes a paging DCI message. In some examples, the message in the first signal indicates one or more SIBs that are updated for a system information modification period, the one or more SIBs including a MIB, a SIB1, OSI, or any combination thereof. In some examples, receiving the second signal in the second BWP is further based on the message in the first signal indicating the one or more SIBs that are updated for the system information modification period. In some examples, the message in the first signal further indicates a UE type associated with the updated system information.

In some examples, the system information in the second signal is first system information, and the system information manager 830 may be configured as or otherwise support a means for receiving, after monitoring for the third signal, a fourth signal in the second BWP of the carrier based on receiving the message in the first signal and on the scheduling parameter, the fourth signal including second system information for the carrier. In some examples, the fourth signal is received based on a quantity of slots between a first search space including the first system information and a second search space including the second system information, a first scheduling offset associated with the first system information, a second scheduling offset associated with the second system information, a UE capability parameter, or any combination thereof.

In some examples, the signal manager 825 may be configured as or otherwise support a means for transmitting an uplink signal in response to receiving the system information in the second signal, where monitoring for the third signal in the third BWP is based on transmitting the uplink signal. In some examples, the system information in the second signal is first system information, and the system information manager 830 may be configured as or otherwise support a means for receiving, after monitoring for the third signal, a fourth signal in the second BWP of the carrier based on receiving the message in the first signal and on transmitting the uplink signal, the fourth signal including second system information for the carrier.

In some examples, the system information in the second signal is first system information, and the system information manager 830 may be configured as or otherwise support a means for refraining from monitoring for a fourth signal in the second BWP of the carrier based on receiving the message in the first signal and on transmitting the uplink signal, the fourth signal including second system information for the carrier. In some examples, monitoring for the third signal in the third BWP is based on transmitting the uplink signal.

In some examples, the first BWP and the third BWP are a same BWP, and the beam failure recovery manager 845 may be configured as or otherwise support a means for transmitting a fourth signal indicating a beam failure recovery procedure based on a beam quality in the first BWP failing to satisfy a threshold. In some examples, the signal manager 825 may be configured as or otherwise support a means for receiving, in the third signal, a message indicating that the UE is to receive updated system information. In some examples, the system information manager 830 may be configured as or otherwise support a means for refraining from receiving the updated system information based on transmitting the fourth signal indicating the beam failure recovery procedure.

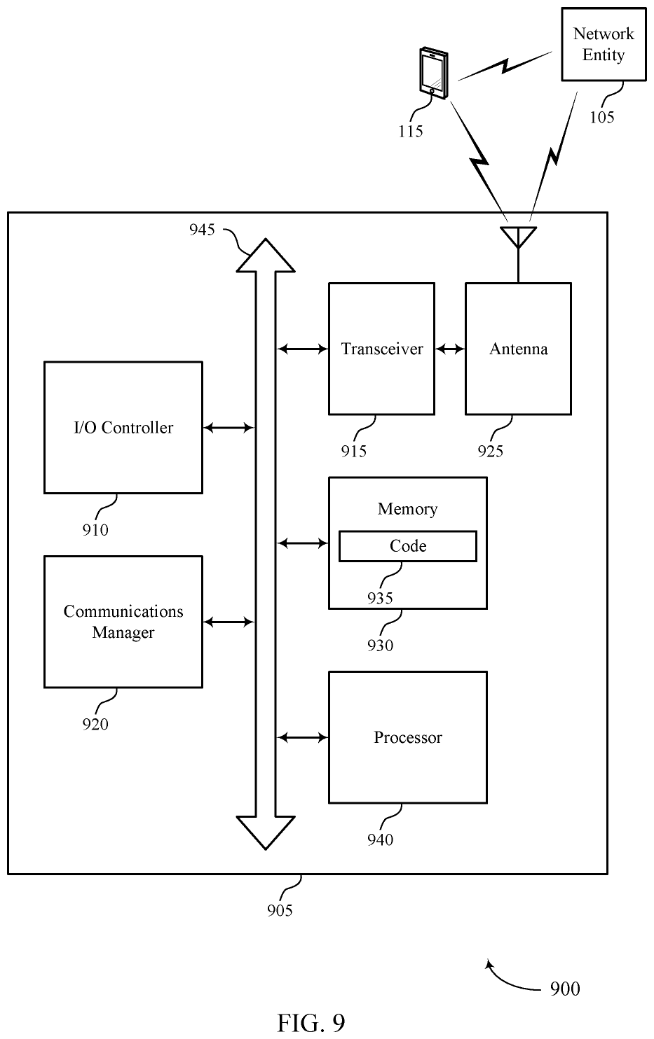

FIG. 9 shows a diagram of a system 900 including a device 905 that supports techniques for BWP switching in accordance with aspects of the present disclosure. The device 905 may be an example of or include the components of a device 605, a device 705, or a UE 115 as described herein. The device 905 may communicate wirelessly with one or more network entities 105, UEs 115, or any combination thereof. The device 905 may include components for bi-directional voice and data communications including components for transmitting and receiving communications, such as a communications manager 920, an input/output (I/O) controller 910, a transceiver 915, an antenna 925, a memory 930, code 935, and a processor 940. These components may be in electronic communication or otherwise coupled (e.g., operatively, communicatively, functionally, electronically, electrically) via one or more buses (e.g., a bus 945).

The I/O controller 910 may manage input and output signals for the device 905. The I/O controller 910 may also manage peripherals not integrated into the device 905. In some cases, the I/O controller 910 may represent a physical connection or port to an external peripheral. In some cases, the I/O controller 910 may utilize an operating system such as iOS®, ANDROID®, MS-DOS®, MS-WINDOWS®, OS/2®, UNIX®, LINUX®, or another known operating system. Additionally, or alternatively, the I/O controller 910 may represent or interact with a modem, a keyboard, a mouse, a touchscreen, or a similar device. In some cases, the I/O controller 910 may be implemented as part of a processor, such as the processor 940. In some cases, a user may interact with the device 905 via the I/O controller 910 or via hardware components controlled by the I/O controller 910.

In some cases, the device 905 may include a single antenna 925. However, in some other cases, the device 905 may have more than one antenna 925, which may be capable of concurrently transmitting or receiving multiple wireless transmissions. The transceiver 915 may communicate bi-directionally, via the one or more antennas 925, wired, or wireless links as described herein. For example, the transceiver 915 may represent a wireless transceiver and may communicate bi-directionally with another wireless transceiver. The transceiver 915 may also include a modem to modulate the packets, to provide the modulated packets to one or more antennas 925 for transmission, and to demodulate packets received from the one or more antennas 925. The transceiver 915, or the transceiver 915 and one or more antennas 925, may be an example of a transmitter 615, a transmitter 715, a receiver 610, a receiver 710, or any combination thereof or component thereof, as described herein.

The memory 930 may include random access memory (RAM) and read-only memory (ROM). The memory 930 may store computer-readable, computer-executable code 935 including instructions that, when executed by the processor 940, cause the device 905 to perform various functions described herein. The code 935 may be stored in a non-transitory computer-readable medium such as system memory or another type of memory. In some cases, the code 935 may not be directly executable by the processor 940 but may cause a computer (e.g., when compiled and executed) to perform functions described herein. In some cases, the memory 930 may contain, among other things, a basic I/O system (BIOS) which may control basic hardware or software operation such as the interaction with peripheral components or devices.

The processor 940 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 940 may be configured to operate a memory array using a memory controller. In some other cases, a memory controller may be integrated into the processor 940. The processor 940 may be configured to execute computer-readable instructions stored in a memory (e.g., the memory 930) to cause the device 905 to perform various functions (e.g., functions or tasks supporting techniques for BWP switching). For example, the device 905 or a component of the device 905 may include a processor 940 and memory 930 coupled to the processor 940, the processor 940 and memory 930 configured to perform various functions described herein.

The communications manager 920 may support wireless communication at the device 905 (e.g., a UE) in accordance with examples as disclosed herein. For example, the communications manager 920 may be configured as or otherwise support a means for monitoring for a first signal in a first BWP of a carrier. The communications manager 920 may be configured as or otherwise support a means for receiving a second signal in a second BWP of the carrier based on a trigger indicating that the UE is to receive the second signal in the second BWP, the second signal including system information for the carrier, a paging message, or both.

By including or configuring the communications manager 920 in accordance with examples as described herein, the device 905 may support techniques for improved communication reliability, improved user experience related to reduced processing, reduced power consumption, more efficient utilization of communication resources, improved coordination between devices, longer battery life, or improved utilization of processing capability.

In some examples, the communications manager 920 may be configured to perform various operations (e.g., receiving, monitoring, transmitting) using or otherwise in cooperation with the transceiver 915, the one or more antennas 925, or any combination thereof. Although the communications manager 920 is illustrated as a separate component, in some examples, one or more functions described with reference to the communications manager 920 may be supported by or performed by the processor 940, the memory 930, the code 935, or any combination thereof. For example, the code 935 may include instructions executable by the processor 940 to cause the device 905 to perform various aspects of techniques for BWP switching as described herein, or the processor 940 and the memory 930 may be otherwise configured to perform or support such operations.

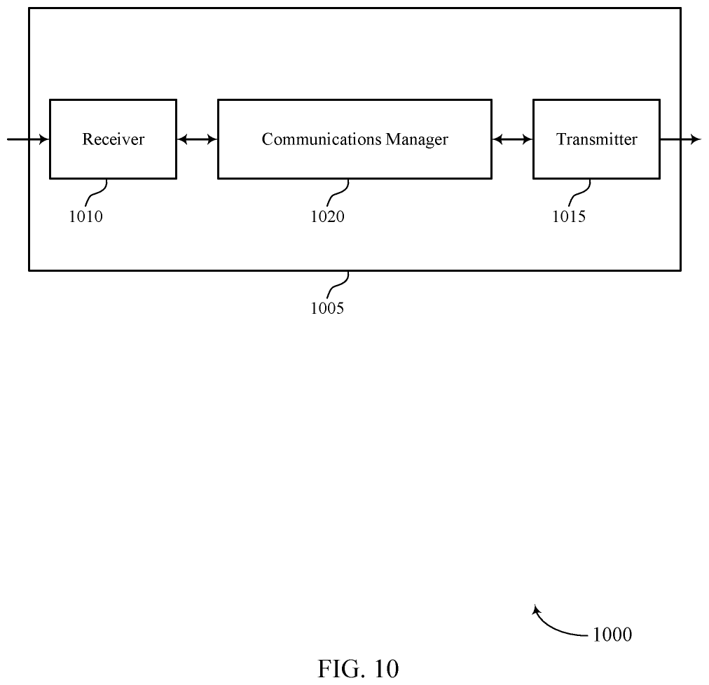

FIG. 10 shows a block diagram 1000 of a device 1005 that supports techniques for BWP switching in accordance with aspects of the present disclosure. The device 1005 may be an example of aspects of a network entity 105 as described herein. The device 1005 may include a receiver 1010, a transmitter 1015, and a communications manager 1020. The device 1005 may also include a processor. Each of these components may be in communication with one another (e.g., via one or more buses).

The receiver 1010 may provide a means for receiving information such as packets, user data, control information, or any combination thereof associated with various information channels (e.g., control channels, data channels, information channels related to techniques for BWP switching). Information may be passed on to other components of the device 1005. The receiver 1010 may utilize a single antenna or a set of multiple antennas.

The transmitter 1015 may provide a means for transmitting signals generated by other components of the device 1005. For example, the transmitter 1015 may transmit information such as packets, user data, control information, or any combination thereof associated with various information channels (e.g., control channels, data channels, information channels related to techniques for BWP switching). In some examples, the transmitter 1015 may be co-located with a receiver 1010 in a transceiver module. The transmitter 1015 may utilize a single antenna or a set of multiple antennas.

The communications manager 1020, the receiver 1010, the transmitter 1015, or various combinations thereof or various components thereof may be examples of means for performing various aspects of techniques for BWP switching as described herein. For example, the communications manager 1020, the receiver 1010, the transmitter 1015, or various combinations or components thereof may support a method for performing one or more of the functions described herein.

In some examples, the communications manager 1020, the receiver 1010, the transmitter 1015, or various combinations or components thereof may be implemented in hardware (e.g., in communications management circuitry). The hardware may include a processor, a DSP, an ASIC, an FPGA or other programmable logic device, a discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 1020, the receiver 1010, the transmitter 1015, or various combinations or components thereof may be implemented in code (e.g., as communications management software or firmware) executed by a processor. If implemented in code executed by a processor, the functions of the communications manager 1020, the receiver 1010, the transmitter 1015, or various combinations or components thereof may be performed by a general-purpose processor, a DSP, a CPU, an ASIC, an FPGA, or any combination of these or other programmable logic devices (e.g., configured as or otherwise supporting a means for performing the functions described in the present disclosure).

In some examples, the communications manager 1020 may be configured to perform various operations (e.g., receiving, monitoring, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to receive information, transmit information, or perform various other operations as described herein.

The communications manager 1020 may support wireless communication in accordance with examples as disclosed herein. For example, the communications manager 1020 may be configured as or otherwise support a means for transmitting, to a UE, a first signal in a first BWP of a carrier. The communications manager 1020 may be configured as or otherwise support a means for transmitting a second signal in a second BWP of the carrier based on a trigger indicating that the UE is to receive the second signal in the second BWP, the second signal including system information for the carrier, a paging message, or both.

By including or configuring the communications manager 1020 in accordance with examples as described herein, the device 1005 (e.g., a processor controlling or otherwise coupled to the receiver 1010, the transmitter 1015, the communications manager 1020, or a combination thereof) may support techniques for reduced processing, reduced power consumption, or more efficient utilization of communication resources.

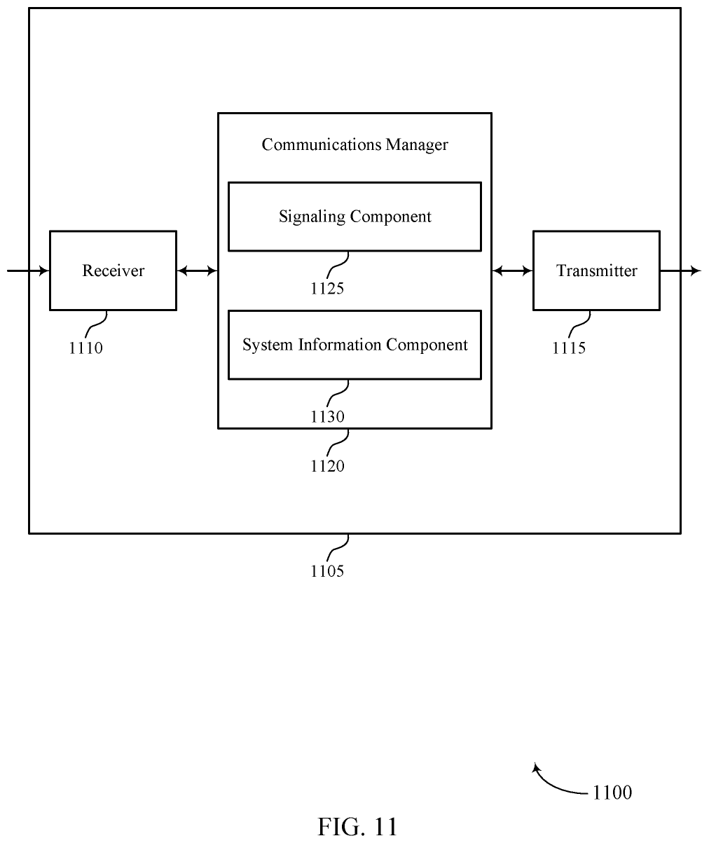

FIG. 11 shows a block diagram 1100 of a device 1105 that supports techniques for BWP switching in accordance with aspects of the present disclosure. The device 1105 may be an example of aspects of a device 1005 or a network entity 105 as described herein. The device 1105 may include a receiver 1110, a transmitter 1115, and a communications manager 1120. The device 1105 may also include a processor. Each of these components may be in communication with one another (e.g., via one or more buses).

The receiver 1110 may provide a means for receiving information such as packets, user data, control information, or any combination thereof associated with various information channels (e.g., control channels, data channels, information channels related to techniques for BWP switching). Information may be passed on to other components of the device 1105. The receiver 1110 may utilize a single antenna or a set of multiple antennas.

The transmitter 1115 may provide a means for transmitting signals generated by other components of the device 1105. For example, the transmitter 1115 may transmit information such as packets, user data, control information, or any combination thereof associated with various information channels (e.g., control channels, data channels, information channels related to techniques for BWP switching). In some examples, the transmitter 1115 may be co-located with a receiver 1110 in a transceiver module. The transmitter 1115 may utilize a single antenna or a set of multiple antennas.

The device 1105, or various components thereof, may be an example of means for performing various aspects of techniques for BWP switching as described herein. For example, the communications manager 1120 may include a signaling component 1125 a system information component 1130, or any combination thereof. The communications manager 1120 may be an example of aspects of a communications manager 1020 as described herein. In some examples, the communications manager 1120, or various components thereof, may be configured to perform various operations (e.g., receiving, monitoring, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to receive information, transmit information, or perform various other operations as described herein.

The communications manager 1120 may support wireless communication in accordance with examples as disclosed herein. The signaling component 1125 may be configured as or otherwise support a means for transmitting, to a UE, a first signal in a first BWP of a carrier. The system information component 1130 may be configured as or otherwise support a means for transmitting a second signal in a second BWP of the carrier based on a trigger indicating that the UE is to receive the second signal in the second BWP, the second signal including system information for the carrier, a paging message, or both.

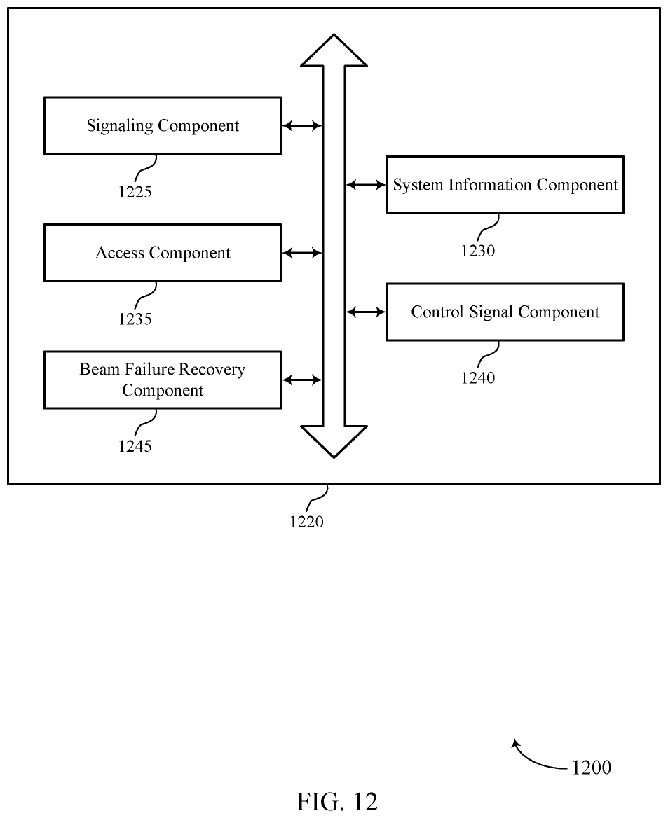

FIG. 12 shows a block diagram 1200 of a communications manager 1220 that supports techniques for BWP switching in accordance with aspects of the present disclosure. The communications manager 1220 may be an example of aspects of a communications manager 1020, a communications manager 1120, or both, as described herein. The communications manager 1220, or various components thereof, may be an example of means for performing various aspects of techniques for BWP switching as described herein. For example, the communications manager 1220 may include a signaling component 1225, a system information component 1230, an access component 1235, a control signal component 1240, a beam failure recovery component 1245, or any combination thereof. Each of these components may communicate, directly or indirectly, with one another (e.g., via one or more buses).

The communications manager 1220 may support wireless communication in accordance with examples as disclosed herein. The signaling component 1225 may be configured as or otherwise support a means for transmitting, to a UE, a first signal in a first BWP of a carrier. The system information component 1230 may be configured as or otherwise support a means for transmitting a second signal in a second BWP of the carrier based on a trigger indicating that the UE is to receive the second signal in the second BWP, the second signal including system information for the carrier, a paging message, or both. In some examples, the signaling component 1225 may be configured as or otherwise support a means for transmitting a third signal in a third BWP of the carrier based on a scheduling parameter associated with receiving the second signal at the UE.

In some examples, the access component 1235 may be configured as or otherwise support a means for transmitting, prior to transmitting the first signal in the first BWP, signaling in the second BWP, where the signaling indicates an access configuration for operating on the carrier, where transmitting the first signal in the first BWP is based on transmitting the signaling.

In some examples, the control signal component 1240 may be configured as or otherwise support a means for transmitting a control signal to the UE, where the trigger indicating that the UE is to receive the second signal in the second BWP includes the control signal. In some examples, the control signal further indicates a switch from the second BWP to the third BWP. In some examples, the control signal includes the scheduling parameter associated with receiving the second signal at the UE.

In some examples, the control signal includes a DCI message, a MAC-CE, a RRC message, or any combination thereof. In some examples, the DCI message may be scrambled using a P-RNTI. In some examples, the trigger indicating that the UE is to receive the second signal in the second BWP includes an expiration of a timer.

In some examples, each of a first switch duration corresponding to switching from the first BWP to the second BWP and a second switch duration corresponding to switching from the second BWP to the third BWP is based on a subcarrier spacing of the carrier, a frequency range of the carrier, a UE capability parameter received from the UE, or any combination thereof. In some examples, the UE capability parameter includes a duplexing mode parameter, a quantity of phase locked loops associated with tracking signals at the UE, or both.

In some examples, a first switch duration corresponding to switching from the first BWP to the second BWP, a duration corresponding to receiving the second signal in the second BWP at the UE, a second switch duration corresponding to switching from the second BWP to the third BWP, or any combination thereof, correspond to a scheduled measurement gap. In some examples, the signaling component 1225 may be configured as or otherwise support a means for refraining from transmitting signaling to the UE in the first BWP in the scheduled measurement gap.

In some examples, a first switch duration corresponding to switching from the first BWP to the second BWP is based on one or more reference signals associated with receiving signaling in the second BWP at the UE. In some examples, the second signal has a QCL relationship with the one or more reference signals. In some examples, a second switch duration corresponding to switching from the second BWP to the third BWP is based on one or more reference signals associated with receiving signaling in the third BWP at the UE. In some examples, the third signal has a QCL relationship with the one or more reference signals.

In some examples, the second switch duration is further based on a first processing duration associated with processing the one or more reference signals, a second processing duration associated with processing the second signal, or both, indicated by the UE. In some examples, a first switch duration corresponding to switching from the first BWP to the second BWP is different than a second switch duration corresponding to switching from the second BWP to the third BWP. In some examples, the second switch duration is less than the first switch duration.

In some examples, the second signal further includes a control signal, a data signal, or both. In some examples, the second signal has a QCL relationship with one or more reference signals associated with receiving signaling in the second BWP. In some examples, the one or more reference signals include an SSB, a CSI-RS, or both. In some examples, the system information for the carrier includes one or more SIBs. In some examples, a SIB of the one or more SIBs includes a position reference signal. In some examples, the first BWP and the third BWP are a same BWP.

In some examples, the signaling component 1225 may be configured as or otherwise support a means for transmitting, in the first signal, a message indicating that the UE is to receive updated system information, where the trigger indicating that the UE is to receive the second signal in the second BWP includes the message in the first signal. In some examples, the message in the first signal includes a paging DCI message. In some examples, the message in the first signal indicates one or more SIBs that are updated for a system information modification period, the one or more SIBs including a MIB, a SIB1, OSI, or any combination thereof. In some examples, the message in the first signal further indicates a UE type associated with the updated system information.

In some examples, the system information in the second signal is first system information, and the system information component 1230 may be configured as or otherwise support a means for transmitting, after transmitting the third signal, a fourth signal in the second BWP of the carrier based on transmitting the message in the first signal and on the scheduling parameter, the fourth signal including second system information for the carrier. In some examples, the fourth signal is transmitted based on a quantity of slots between a first search space including the first system information and a second search space including the second system information, a first scheduling offset associated with the first system information, a second scheduling offset associated with the second system information, a UE capability parameter, or any combination thereof. In some examples, the signaling component 1225 may be configured as or otherwise support a means for receiving an uplink signal in response to transmitting the system information in the second signal, where transmitting the third signal in the third BWP is based on receiving the uplink signal.

In some examples, the system information in the second signal is first system information, and the system information component 1230 may be configured as or otherwise support a means for transmitting, after transmitting the third signal, a fourth signal in the second BWP of the carrier based on transmitting the message in the first signal and on receiving the uplink signal, the fourth signal including second system information for the carrier. In some examples, transmitting the third signal in the third BWP is based on receiving the uplink signal. In some examples, the first BWP and the third BWP are a same BWP, and the beam failure recovery component 1245 may be configured as or otherwise support a means for receiving a fourth signal indicating a beam failure recovery procedure based on a beam quality in the first BWP satisfying a threshold.

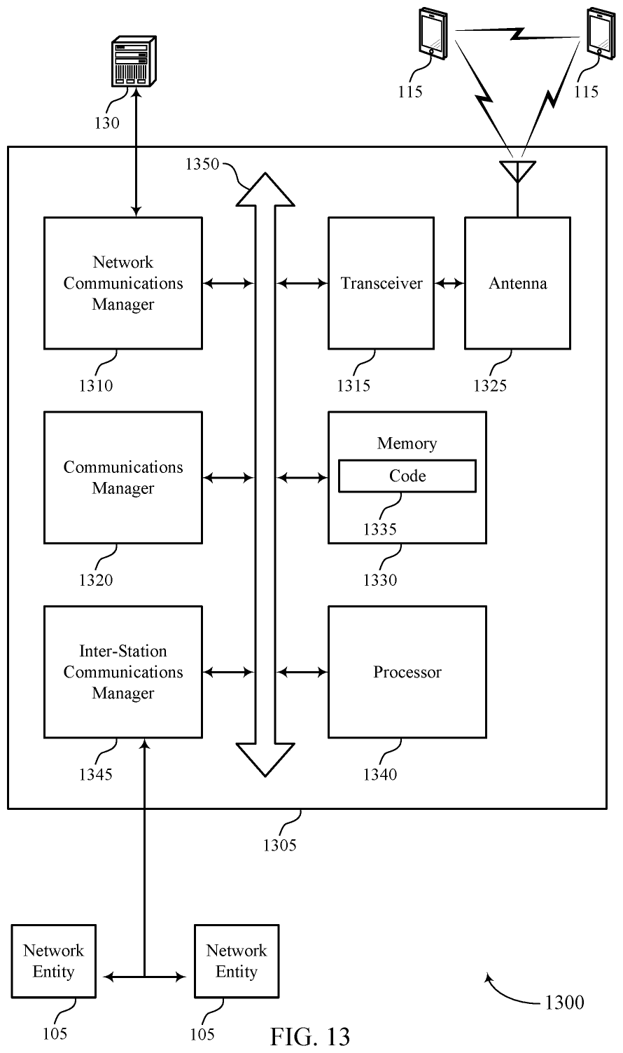

FIG. 13 shows a diagram of a system 1300 including a device 1305 that supports techniques for BWP switching in accordance with aspects of the present disclosure. The device 1305 may be an example of or include the components of a device 1005, a device 1105, or a network entity 105 as described herein. The device 1305 may communicate wirelessly with one or more network entities 105, UEs 115, or any combination thereof. The device 1305 may include components for bi-directional voice and data communications including components for transmitting and receiving communications, such as a communications manager 1320, a network communications manager 1310, a transceiver 1315, an antenna 1325, a memory 1330, code 1335, a processor 1340, and an inter-station communications manager 1345. These components may be in electronic communication or otherwise coupled (e.g., operatively, communicatively, functionally, electronically, electrically) via one or more buses (e.g., a bus 1350).

The network communications manager 1310 may manage communications with a core network 130 (e.g., via one or more wired backhaul links). For example, the network communications manager 1310 may manage the transfer of data communications for client devices, such as one or more UEs 115.

In some cases, the device 1305 may include a single antenna 1325. However, in some other cases the device 1305 may have more than one antenna 1325, which may be capable of concurrently transmitting or receiving multiple wireless transmissions. The transceiver 1315 may communicate bi-directionally, via the one or more antennas 1325, wired, or wireless links as described herein. For example, the transceiver 1315 may represent a wireless transceiver and may communicate bi-directionally with another wireless transceiver. The transceiver 1315 may also include a modem to modulate the packets, to provide the modulated packets to one or more antennas 1325 for transmission, and to demodulate packets received from the one or more antennas 1325. The transceiver 1315, or the transceiver 1315 and one or more antennas 1325, may be an example of a transmitter 1015, a transmitter 1115, a receiver 1010, a receiver 1110, or any combination thereof or component thereof, as described herein.

The memory 1330 may include RAM and ROM. The memory 1330 may store computer-readable, computer-executable code 1335 including instructions that, when executed by the processor 1340, cause the device 1305 to perform various functions described herein. The code 1335 may be stored in a non-transitory computer-readable medium such as system memory or another type of memory. In some cases, the code 1335 may not be directly executable by the processor 1340 but may cause a computer (e.g., when compiled and executed) to perform functions described herein. In some cases, the memory 1330 may contain, among other things, a BIOS which may control basic hardware or software operation such as the interaction with peripheral components or devices.

The processor 1340 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1340 may be configured to operate a memory array using a memory controller. In some other cases, a memory controller may be integrated into the processor 1340. The processor 1340 may be configured to execute computer-readable instructions stored in a memory (e.g., the memory 1330) to cause the device 1305 to perform various functions (e.g., functions or tasks supporting techniques for BWP switching). For example, the device 1305 or a component of the device 1305 may include a processor 1340 and memory 1330 coupled to the processor 1340, the processor 1340 and memory 1330 configured to perform various functions described herein.

The inter-station communications manager 1345 may manage communications with other network entities 105, and may include a controller or scheduler for controlling communications with UEs 115 in cooperation with other network entities 105. For example, the inter-station communications manager 1345 may coordinate scheduling for transmissions to UEs 115 for various interference mitigation techniques such as beamforming or joint transmission. In some examples, the inter-station communications manager 1345 may provide an X2 interface within an LTE/LTE-A wireless communications network technology to provide communication between network entities 105.

The communications manager 1320 may support wireless communication in accordance with examples as disclosed herein. For example, the communications manager 1320 may be configured as or otherwise support a means for transmitting, to a UE, a first signal in a first BWP of a carrier. The communications manager 1320 may be configured as or otherwise support a means for transmitting a second signal in a second BWP of the carrier based on a trigger indicating that the UE is to receive the second signal in the second BWP, the second signal including system information for the carrier, a paging message, or both.

By including or configuring the communications manager 1320 in accordance with examples as described herein, the device 1305 may support techniques for improved communication reliability, reduced power consumption, more efficient utilization of communication resources, improved coordination between devices, or improved utilization of processing capability.

In some examples, the communications manager 1320 may be configured to perform various operations (e.g., receiving, monitoring, transmitting) using or otherwise in cooperation with the transceiver 1315, the one or more antennas 1325, or any combination thereof. Although the communications manager 1320 is illustrated as a separate component, in some examples, one or more functions described with reference to the communications manager 1320 may be supported by or performed by the processor 1340, the memory 1330, the code 1335, or any combination thereof. For example, the code 1335 may include instructions executable by the processor 1340 to cause the device 1305 to perform various aspects of techniques for BWP switching as described herein, or the processor 1340 and the memory 1330 may be otherwise configured to perform or support such operations.

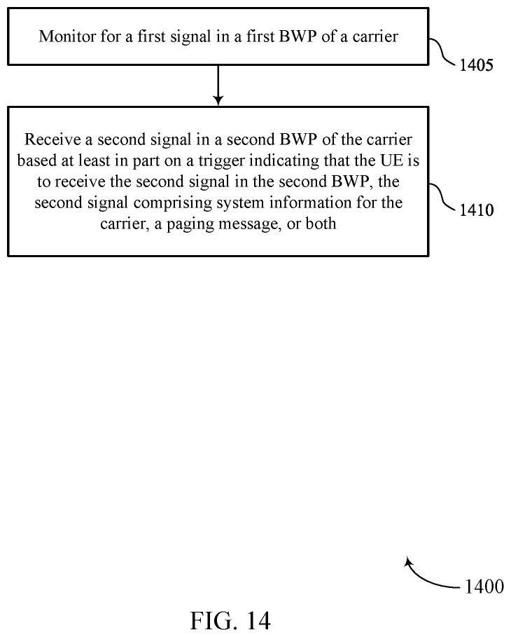

FIG. 14 shows a flowchart illustrating a method 1400 that supports techniques for BWP switching in accordance with aspects of the present disclosure. The operations of the method 1400 may be implemented by a UE or its components as described herein. For example, the operations of the method 1400 may be performed by a UE 115 as described with reference to FIGS. 1 through 9. In the example of FIG. 14, a UE with reduced capabilities may switch from a first BWP to a second BWP to receive system information for a carrier that includes the first BWP and the second BWP. In some examples, a UE may execute a set of instructions to control the functional elements of the UE to perform the described functions. Additionally, or alternatively, the UE may perform aspects of the described functions using special-purpose hardware.

At 1405, the method may include monitoring for a first signal in a first BWP of a carrier. For example, a UE may monitor a portion of a radio frequency spectrum band of the carrier for the first signal. The first signal may be an RRC message, a MAC-CE, or a DCI. In some examples, the first BWP may be referred to as an active BWP that is smaller than an overall BWP of the carrier. Additionally, the first BWP may not include a second BWP, which may be referred to as an initial BWP, where the second BWP may include frequency resources for receiving system information. The operations of 1405 may be performed in accordance with examples as disclosed herein. In some examples, aspects of the operations of 1405 may be performed by a signal manager 825 as described with reference to FIG. 8.

At 1410, the method may include receiving a second signal in a second BWP of the carrier based on a trigger indicating that the UE is to receive the second signal in the second BWP, the second signal including system information for the carrier, a paging message, or both. The system information may be part of one or more SIBs, including a MIB, a SIB1, a SIB2, a SIB3, etc. In some examples, the UE may receive the second signal in the second BWP, for example, after switching to operate in the second BWP based on the trigger (e.g., the first control signal, or an expiration of a timer). In some examples, the UE may wait a duration before performing the switch, for example to align the switch with a system information reception opportunity, which in some cases may be referred to as a system information modification boundary or a system information window. The operations of 1410 may be performed in accordance with examples as disclosed herein. In some examples, aspects of the operations of 1410 may be performed by a system information manager 830 as described with reference to FIG. 8.

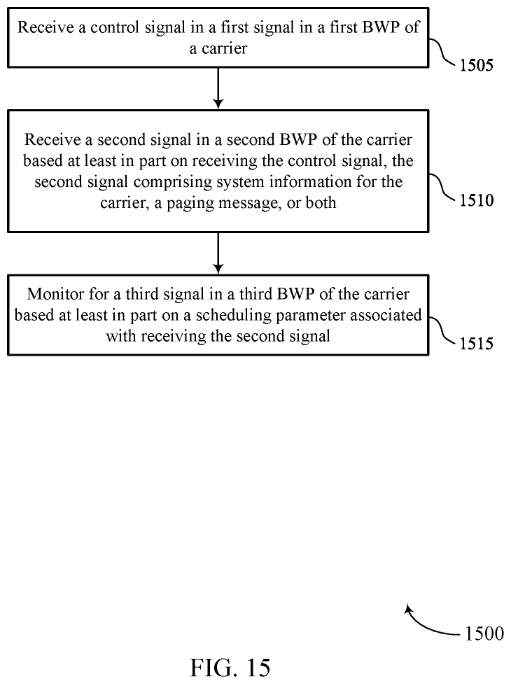

FIG. 15 shows a flowchart illustrating a method 1500 that supports techniques for BWP switching in accordance with aspects of the present disclosure. The operations of the method 1500 may be implemented by a UE or its components as described herein. For example, the operations of the method 1500 may be performed by a UE 115 as described with reference to FIGS. 1 through 9. In the example of FIG. 15, a UE with reduced capabilities may switch from a first BWP to a second BWP to receive system information for a carrier that includes the first BWP and the second BWP. The UE may receive additional signaling (e.g., data, control signaling, reference signals) in the second BWP. In some examples, a BWP switching duration may include additional time to process the system information received in the second BWP, for example, if the system information includes instructions to switch to a third BWP (e.g., rather than returning to the first BWP). In some examples, a UE may execute a set of instructions to control the functional elements of the UE to perform the described functions. Additionally, or alternatively, the UE may perform aspects of the described functions using special-purpose hardware.

At 1505, the method may include receiving a control signal in a first signal in a first BWP of a carrier. For example, a UE may receive the control signal in the first signal over a first portion of a radio frequency spectrum band of the carrier. In some examples, the control signal may be a paging DCI. In some examples, the first BWP may be smaller than an overall BWP of the carrier. Additionally, the first BWP may not include a second BWP, where the second BWP may include frequency resources for receiving system information. The operations of 1505 may be performed in accordance with examples as disclosed herein. In some examples, aspects of the operations of 1505 may be performed by a control signal manager 840 as described with reference to FIG. 8.

At 1510, the method may include receiving a second signal in a second BWP of the carrier based on receiving the control signal, the second signal including system information for the carrier, a paging message, or both. In some examples, a UE may receive the second signal in the second BWP of the carrier, for example, after switching to operate in the second BWP. The system information may be part of one or more SIBs, including a MIB, a SIB1, a SIB2, a SIB3, etc. The operations of 1510 may be performed in accordance with examples as disclosed herein. In some examples, aspects of the operations of 1510 may be performed by a system information manager 830 as described with reference to FIG. 8.

At 1515, the method may include monitoring for a third signal in a third BWP of the carrier based on a scheduling parameter associated with receiving the second signal. For example, a BWP switching duration may include additional time to process the system information received in the second BWP, for example, if the system information or other signaling includes instructions to switch to the third BWP (e.g., rather than returning to the first BWP). The operations of 1515 may be performed in accordance with examples as disclosed herein. In some examples, aspects of the operations of 1515 may be performed by a signal manager 825 as described with reference to FIG. 8.

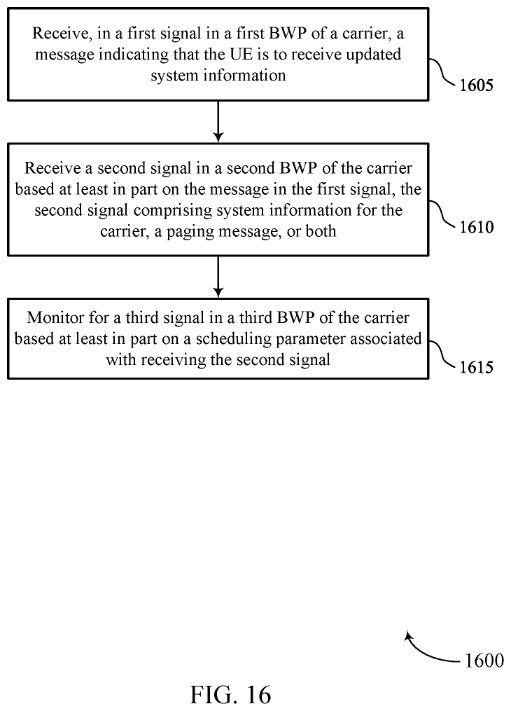

FIG. 16 shows a flowchart illustrating a method 1600 that supports techniques for BWP switching in accordance with aspects of the present disclosure. The operations of the method 1600 may be implemented by a UE or its components as described herein. For example, the operations of the method 1600 may be performed by a UE 115 as described with reference to FIGS. 1 through 9. In the example of FIG. 16, a UE with reduced capabilities may switch from a first BWP to a second BWP to receive updated system information for a carrier that includes the first BWP and the second BWP. The UE may receive additional signaling (e.g., control signaling) in a third BWP. In some examples, the UE may process the system information received in the second BWP, which may include instructions to switch to a third BWP (e.g., rather than returning to the first BWP) to receive additional signaling. In some examples, a UE may execute a set of instructions to control the functional elements of the UE to perform the described functions. Additionally, or alternatively, the UE may perform aspects of the described functions using special-purpose hardware.

At 1605, the method may include receiving, in a first signal in a first BWP of a carrier, a message indicating that the UE is to receive updated system information. For example, the UE may receive, in a first portion of a radio frequency spectrum band of the carrier, the message indicating that the UE is to receive updated system information. The message may be an RRC message, a MAC-CE, or a DCI. In some examples, the first BWP may be smaller than an overall BWP of the carrier. The operations of 1605 may be performed in accordance with examples as disclosed herein. In some examples, aspects of the operations of 1605 may be performed by a signal manager 825 as described with reference to FIG. 8.

At 1610, the method may include receiving a second signal in a second BWP of the carrier based on the message in the first signal, the second signal including system information for the carrier, a paging message, or both. For example, the UE may receive the second signal in a second portion of a radio frequency spectrum band of the carrier. In some examples, the first BWP may not include the second BWP, where the second BWP may include frequency resources for receiving the system information. The operations of 1610 may be performed in accordance with examples as disclosed herein. In some examples, aspects of the operations of 1610 may be performed by a system information manager 830 as described with reference to FIG. 8.

At 1615, the method may include monitoring for a third signal in a third BWP of the carrier based on a scheduling parameter associated with receiving the second signal. For example, the UE may receive additional signaling (e.g., control signaling) in a third portion of a radio frequency spectrum band of the carrier. The first BWP and the second BWP may not include the third BWP, where the third BWP may include frequency resources for transmitting or receiving additional signaling. The operations of 1615 may be performed in accordance with examples as disclosed herein. In some examples, aspects of the operations of 1615 may be performed by a signal manager 825 as described with reference to FIG. 8.

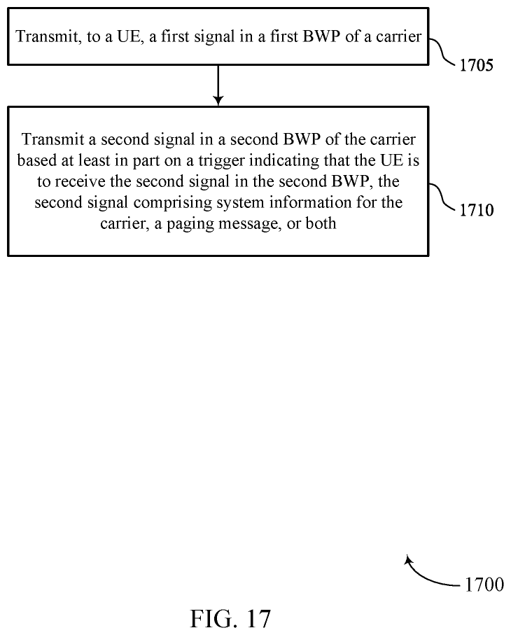

FIG. 17 shows a flowchart illustrating a method 1700 that supports techniques for BWP switching in accordance with aspects of the present disclosure. The operations of the method 1700 may be implemented by a network entity or its components as described herein. For example, the operations of the method 1700 may be performed by a network entity 105 as described with reference to FIGS. 1 through 5 and 10 through 13. In the example of FIG. 15, a network entity may enable a UE with reduced capabilities to switch from a first BWP to a second BWP to receive system information for a carrier that includes the first BWP and the second BWP. In some examples, a network entity may execute a set of instructions to control the functional elements of the network entity to perform the described functions. Additionally, or alternatively, the network entity may perform aspects of the described functions using special-purpose hardware.

At 1705, the method may include transmitting, to a UE, a first signal in a first BWP of a carrier. For example, a network entity may transmit the first signal in a portion of a radio frequency spectrum band of the carrier. The first signal may be an RRC message, a MAC-CE, or a DCI. In some examples, the first BWP may be smaller than an overall BWP of the carrier. Additionally, the first BWP may not include a second BWP, where the second BWP may include frequency resources for transmitting system information. The operations of 1705 may be performed in accordance with examples as disclosed herein. In some examples, aspects of the operations of 1705 may be performed by a signaling component 1225 as described with reference to FIG. 12.

At 1710, the method may include transmitting a second signal in a second BWP of the carrier based on a trigger indicating that the UE is to receive the second signal in the second BWP, the second signal including system information for the carrier, a paging message, or both. The system information may be part of one or more SIBs, including a MIB, a SIB1, a SIB2, a SIB3, etc. In some examples, the network entity may transmit the second signal in the second BWP, for example, after switching to operate in the second BWP. The operations of 1710 may be performed in accordance with examples as disclosed herein. In some examples, aspects of the operations of 1710 may be performed by a system information component 1230 as described with reference to FIG. 12.

The following provides an overview of aspects of the present disclosure:

The following provides an overview of aspects of the present disclosure:

Aspect 1: A method of wireless communication at a UE, comprising: monitoring for a first signal in a first BWP of a carrier; and receiving a second signal in a second BWP of the carrier based at least in part on a trigger indicating that the UE is to receive the second signal in the second BWP, the second signal comprising system information for the carrier, a paging message, or both.

Aspect 2: The method of aspect 1, further comprising: monitoring for a third signal in a third BWP of the carrier based at least in part on a scheduling parameter associated with receiving the second signal.

Aspect 3: The method of any of aspects 1 through 2, further comprising: receiving a control signal, wherein the trigger indicating that the UE is to receive the second signal in the second BWP comprises the control signal.

Aspect 4: The method of aspect 3, wherein the control signal comprises an indication of a switch from the second BWP to a third BWP, the scheduling parameter associated with receiving the second signal, a DCI message, a MAC-CE, a RRC message, or any combination thereof.

Aspect 5: The method of any of aspects 1 through 4, wherein the trigger indicating that the UE is to receive the second signal in the second BWP comprises an expiration of a timer.

Aspect 6: The method of any of aspects 1 through 5, wherein each of a first switch duration corresponding to switching from the first BWP to the second BWP and a second switch duration corresponding to switching from the second BWP to a third BWP is based at least in part on a subcarrier spacing of the carrier, a frequency range of the carrier, a UE capability parameter, or any combination thereof.

Aspect 7: The method of aspect 6, wherein the UE capability parameter comprises a duplexing mode parameter, a quantity of phase locked loops associated with tracking signals at the UE, or both.

Aspect 8: The method of any of aspects 1 through 7, wherein a first switch duration corresponding to switching from the first BWP to the second BWP, a duration corresponding to receiving the second signal in the second BWP, a second switch duration corresponding to switching from the second BWP to a third BWP, or any combination thereof, correspond to a scheduled measurement gap.

Aspect 9: The method of any of aspects 1 through 8, wherein a first switch duration corresponding to switching from the first BWP to the second BWP is based at least in part on one or more reference signals associated with receiving signaling in the second BWP, and the second signal has a QCL relationship with the one or more reference signals.

Aspect 10: The method of any of aspects 1 through 9, wherein a second switch duration corresponding to switching from the second BWP to a third BWP is based at least in part on one or more reference signals associated with receiving signaling in the third BWP, and a third signal has a QCL relationship with the one or more reference signals.

Aspect 11: The method of aspect 10, wherein the second switch duration is further based at least in part on a first processing duration associated with processing the one or more reference signals, a second processing duration associated with processing the second signal, or both.

Aspect 12: The method of any of aspects 1 through 11, wherein a first switch duration corresponding to switching from the first BWP to the second BWP is different than a second switch duration corresponding to switching from the second BWP to a third BWP.

Aspect 13: The method of any of aspects 1 through 12, wherein the system information for the carrier comprises one or more SIBs, and a SIB of the one or more SIBs comprises a position reference signal.

Aspect 14: The method of any of aspects 1 through 13, wherein the first BWP and a third BWP are a same BWP.

Aspect 15: The method of any of aspects 1 through 14, further comprising: receiving, in the first signal, a message indicating that the UE is to receive updated system information, wherein the trigger indicating that the UE is to receive the second signal in the second BWP comprises the message in the first signal.

Aspect 16: The method of aspect 15, wherein the message in the first signal comprises a paging DCI message.

Aspect 17: The method of any of aspects 15 through 16, wherein the message in the first signal indicates one or more SIBs that are updated for a system information modification period, the one or more SIBs comprising a MIB, a SIB1, OSI, or any combination thereof; and receiving the second signal in the second BWP is further based at least in part on the message in the first signal indicating the one or more SIBs that are updated for the system information modification period.

Aspect 18: The method of any of aspects 15 through 17, wherein the message in the first signal further indicates a UE type associated with the updated system information.

Aspect 19: The method of any of aspects 15 through 18, wherein the system information in the second signal is first system information, and the method further comprising: receiving, after monitoring for a third signal in a third BWP of the carrier, a fourth signal in the second BWP of the carrier based at least in part on receiving the message in the first signal and on the scheduling parameter, the fourth signal comprising second system information for the carrier.

Aspect 20: The method of aspect 19, wherein the fourth signal is received based at least in part on a quantity of slots between a first search space comprising the first system information and a second search space comprising the second system information, a first scheduling offset associated with the first system information, a second scheduling offset associated with the second system information, a UE capability parameter, or any combination thereof.

Aspect 21: The method of any of aspects 15 through 20, further comprising: transmitting an uplink signal in response to receiving the system information in the second signal; and monitoring for a third signal in a third BWP of the carrier based at least in part on transmitting the uplink signal.

Aspect 22: The method of aspect 21, wherein the system information in the second signal is first system information, and the method further comprising: receiving, after monitoring for the third signal, a fourth signal in the second BWP of the carrier based at least in part on receiving the message in the first signal and on transmitting the uplink signal, the fourth signal comprising second system information for the carrier.

Aspect 23: The method of any of aspects 21 through 22, wherein the system information in the second signal is first system information, and the method further comprising: refraining from monitoring for a fourth signal in the second BWP of the carrier based at least in part on receiving the message in the first signal and on transmitting the uplink signal, the fourth signal comprising second system information for the carrier.

Aspect 24: The method of any of aspects 21 through 23, wherein monitoring for the third signal in the third BWP is based at least in part on transmitting the uplink signal.

Aspect 25: The method of any of aspects 1 through 24, wherein the first BWP and a third BWP are a same BWP, and the method further comprising: transmitting a fourth signal indicating a beam failure recovery procedure based at least in part on a beam quality in the first BWP failing to satisfy a threshold.

Aspect 26: The method of aspect 25, further comprising: receiving, in a third signal, a message indicating that the UE is to receive updated system information; and refraining from receiving the updated system information based at least in part on transmitting the fourth signal indicating the beam failure recovery procedure.

Aspect 27: A method of wireless communication, comprising: transmitting, to a UE, a first signal in a first BWP of a carrier; and transmitting a second signal in a second BWP of the carrier based at least in part on a trigger indicating that the UE is to receive the second signal in the second BWP, the second signal comprising system information for the carrier, a paging message, or both.

Aspect 28: The method of aspect 27, further comprising: transmitting a third signal in a third BWP of the carrier based at least in part on a scheduling parameter associated with receiving the second signal at the UE.

Aspect 29: An apparatus comprising a processor; memory coupled with the processor; and instructions stored in the memory and executable by the processor to cause the apparatus to perform a method of any of aspects 1 through 26.

Aspect 30: An apparatus comprising at least one means for performing a method of any of aspects 1 through 26.

Aspect 31: A non-transitory computer-readable medium storing code the code comprising instructions executable by a processor to perform a method of any of aspects 1 through 26.

Aspect 32: An apparatus comprising a processor; memory coupled with the processor; and instructions stored in the memory and executable by the processor to cause the apparatus to perform a method of any of aspects 27 through 28.

Aspect 33: An apparatus comprising at least one means for performing a method of any of aspects 27 through 28.

Aspect 34: A non-transitory computer-readable medium storing code the code comprising instructions executable by a processor to perform a method of any of aspects 27 through 28.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a wide variety of actions and, therefore, “determining” can include calculating, computing, processing, deriving, investigating, looking up (such as via looking up in a table, a database or another data structure), ascertaining and the like. Also, “determining” can include receiving (such as receiving information), accessing (such as accessing data in a memory) and the like. Also, “determining” can include resolving, selecting, choosing, establishing and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. An apparatus for wireless communication at a user equipment (UE), comprising:
a processor;
memory coupled with the processor; and
instructions stored in the memory and executable by the processor to cause the apparatus to:
monitor for a first signal in a first bandwidth part of a carrier; and
receive a second signal in a second bandwidth part of the carrier based at least in part on a trigger indicating that the UE is to receive the second signal in the second bandwidth part, the second signal comprising system information for the carrier, a paging message, or both.

2. The apparatus of claim 1, wherein the instructions are further executable by the processor to cause the apparatus to:
monitor for a third signal in a third bandwidth part of the carrier based at least in part on a scheduling parameter associated with receiving the second signal.

3. The apparatus of claim 1, wherein the instructions are further executable by the processor to cause the apparatus to:
receive a control signal, wherein the trigger indicating that the UE is to receive the second signal in the second bandwidth part comprises the control signal.

4. The apparatus of claim 3, wherein the control signal comprises an indication of a switch from the second bandwidth part to a third bandwidth part, a scheduling parameter associated with receiving the second signal, a downlink control information message, a medium access control (MAC) control element (MAC-CE), a radio resource control message, or any combination thereof.

5. The apparatus of claim 1, wherein the trigger indicating that the UE is to receive the second signal in the second bandwidth part comprises an expiration of a timer.

6. The apparatus of claim 1, wherein each of a first switch duration corresponding to switching from the first bandwidth part to the second bandwidth part and a second switch duration corresponding to switching from the second bandwidth part to a third bandwidth part is based at least in part on a subcarrier spacing of the carrier, a frequency range of the carrier, a UE capability parameter, or any combination thereof.

7. The apparatus of claim 6, wherein the UE capability parameter comprises a duplexing mode parameter, a quantity of phase locked loops associated with tracking signals at the UE, or both.

8. The apparatus of claim 1, wherein a first switch duration corresponding to switching from the first bandwidth part to the second bandwidth part, a duration corresponding to receiving the second signal in the second bandwidth part, a second switch duration corresponding to switching from the second bandwidth part to a third bandwidth part, or any combination thereof, correspond to a scheduled measurement gap.

9. The apparatus of claim 1, wherein:
a first switch duration corresponding to switching from the first bandwidth part to the second bandwidth part is based at least in part on one or more reference signals associated with receiving signaling in the second bandwidth part, and
the second signal has a quasi-co-location relationship with the one or more reference signals.

10. The apparatus of claim 1, wherein:
a second switch duration corresponding to switching from the second bandwidth part to a third bandwidth part is based at least in part on one or more reference signals associated with receiving signaling in the third bandwidth part, and
a third signal has a quasi-co-location relationship with the one or more reference signals.

11. The apparatus of claim 10, wherein the second switch duration is further based at least in part on a first processing duration associated with processing the one or more reference signals, a second processing duration associated with processing the second signal, or both.

12. The apparatus of claim 1, wherein a first switch duration corresponding to switching from the first bandwidth part to the second bandwidth part is different than a second switch duration corresponding to switching from the second bandwidth part to a third bandwidth part.

13. The apparatus of claim 1, wherein:
the system information for the carrier comprises one or more system information blocks, and
a system information block of the one or more system information blocks comprises a position reference signal.

14. The apparatus of claim 1, wherein the first bandwidth part and a third bandwidth part are a same bandwidth part.

15. The apparatus of claim 1, wherein the instructions are further executable by the processor to cause the apparatus to:
receive, in the first signal, a message indicating that the UE is to receive updated system information, wherein the trigger indicating that the UE is to receive the second signal in the second bandwidth part comprises the message in the first signal.

16. The apparatus of claim 15, wherein the message in the first signal comprises a paging downlink control information message.

17. The apparatus of claim 15, wherein:
the message in the first signal indicates one or more system information blocks (SIBs) that are updated for a system information modification period, the one or more SIBs comprising a master information block (MIB), a first system information block (SIB1), other system information (OSI), or any combination thereof; and
to receive the second signal in the second bandwidth part is further based at least in part on the message in the first signal indicating the one or more SIBs that are updated for the system information modification period.

18. The apparatus of claim 15, wherein the message in the first signal further indicates a UE type associated with the updated system information.

19. The apparatus of claim 15, wherein the system information in the second signal is first system information, and the instructions are further executable by the processor to cause the apparatus to:
receive, after monitoring for a third signal in a third bandwidth part of the carrier, a fourth signal in the second bandwidth part of the carrier based at least in part on receiving the message in the first signal and on a scheduling parameter, the fourth signal comprising second system information for the carrier.

20. The apparatus of claim 19, wherein the fourth signal is received based at least in part on a quantity of slots between a first search space comprising the first system information and a second search space comprising the second system information, a first scheduling offset associated with the first system information, a second scheduling offset associated with the second system information, a UE capability parameter, or any combination thereof.

21. The apparatus of claim 15, wherein the instructions are further executable by the processor to cause the apparatus to:
transmit an uplink signal in response to receiving the system information in the second signal; and
monitor for a third signal in a third bandwidth part of the carrier based at least in part on transmitting the uplink signal.

22. The apparatus of claim 21, wherein the system information in the second signal is first system information, and the instructions are further executable by the processor to cause the apparatus to:
receive, after monitoring for the third signal, a fourth signal in the second bandwidth part of the carrier based at least in part on receiving the message in the first signal and on transmitting the uplink signal, the fourth signal comprising second system information for the carrier.

23. The apparatus of claim 21, wherein the system information in the second signal is first system information, and the instructions are further executable by the processor to cause the apparatus to:
refrain from monitoring for a fourth signal in the second bandwidth part of the carrier based at least in part on receiving the message in the first signal and on transmitting the uplink signal, the fourth signal comprising second system information for the carrier.

24. The apparatus of claim 21, wherein to monitor for the third signal in the third bandwidth part is based at least in part on transmitting the uplink signal.

25. The apparatus of claim 1, wherein the first bandwidth part and a third bandwidth part are a same bandwidth part, and the instructions are further executable by the processor to cause the apparatus to:
transmit a fourth signal indicating a beam failure recovery procedure based at least in part on a beam quality in the first bandwidth part failing to satisfy a threshold.

26. The apparatus of claim 25, wherein the instructions are further executable by the processor to cause the apparatus to:
receive, in a third signal, a message indicating that the UE is to receive updated system information; and
refrain from receiving the updated system information based at least in part on transmitting the fourth signal indicating the beam failure recovery procedure.

27. An apparatus for wireless communication, comprising:
a processor;
memory coupled with the processor; and
instructions stored in the memory and executable by the processor to cause the apparatus to:
transmit, to a user equipment (UE), a first signal in a first bandwidth part of a carrier; and
transmit a second signal in a second bandwidth part of the carrier based at least in part on a trigger indicating that the UE is to receive the second signal in the second bandwidth part, the second signal comprising system information for the carrier, a paging message, or both.

28. The apparatus of claim 27, wherein the instructions are further executable by the processor to cause the apparatus to:
transmit a third signal in a third bandwidth part of the carrier based at least in part on a scheduling parameter associated with receiving the second signal at the UE.

29. A method for wireless communication at a user equipment (UE), comprising:
monitoring for a first signal in a first bandwidth part of a carrier; and
receiving a second signal in a second bandwidth part of the carrier based at least in part on a trigger indicating that the UE is to receive the second signal in the second bandwidth part, the second signal comprising system information for the carrier, a paging message, or both.

30. A method for wireless communication, comprising:
transmitting, to a user equipment (UE), a first signal in a first bandwidth part of a carrier; and
transmitting a second signal in a second bandwidth part of the carrier based at least in part on a trigger indicating that the UE is to receive the second signal in the second bandwidth part, the second signal comprising system information for the carrier, a paging message, or both.
